(19) United States
(12) Patent Application Publication
(10) Pub. No.: US 2026/0358111 A1
(43) Pub. Date: Nov. 12, 2026

(54) SENSOR DEVICE ON A FORK OF A MATERIALS HANDLING VEHICLE

(71) Applicant: Crown Equipment Corporation, New Bremen, OH (US)

(72) Inventors: Geoffrey D. Lee, Saint Marys, OH (US); Lee Wente, Minster, OH (US); Eric Pepple, St. Henry, OH (US); Brittney Borgerding, Burkettsville, OH (US)

(21) Appl. No.: 19/666,501

(22) Filed: May 4, 2026

Related U.S. Application Data
(60) Provisional application No. 63/802,676, filed on May 9, 2025.

(51) Int. Cl. G01B 7/30; B66F 9/075; G01D 5/14; G01D 5/16

(52) U.S. Cl. CPC G01B 7/30; B66F 9/0755; G01D 5/145; G01D 5/16

(57) ABSTRACT

A sensor device is provided on a fork of a materials handling vehicle. The sensor device comprises a pivotable load detection arm coupled to the fork and a rotary sensor coupled to the fork and engaged with the load detection arm. The rotary sensor generates rotational signals as the load detection arm pivots relative to the fork.

### CROSS REFERENCE TO RELATED APPLICATIONS

This application claims the benefit of U.S. Provisional Patent Application Ser. No. 63/802,676, filed May 9, 2025, entitled “SENSOR DEVICE ON A FORK OF A MATERIALS HANDLING VEHICLE,” attorney docket CRN 1102 MA.

### BACKGROUND

It is known to provide a system for detecting a position of a load on a fork of a material handling vehicle, where the system comprises a proximity sensor for detecting a sensor flag on a movable arm, see U.S. Pat. No. 11,958,731.

### BRIEF SUMMARY

In accordance with a first aspect, a sensor device is provided on a fork of a materials handling vehicle. The sensor device may comprise a pivotable load detection arm coupled to the fork and a rotary sensor coupled to the fork and engaged with the load detection arm. The rotary sensor may generate rotational signals as the load detection arm pivots relative to the fork.

The load detection arm may be directly coupled to the rotary sensor.

A sensor arm may be coupled to the rotary sensor. The sensor arm may be in engagement with the load detection arm for angular movement with the load detection arm.

The sensor arm may be spring biased in a direction toward the load detection arm such that the sensor arm engages the load detection arm.

The sensor arm may be fixed to the load detection arm.

A spring may be provided for biasing the load detection arm outward. As a load is received and moves along the fork in a direction toward the fork, the load may engage with the load detection arm, causing the load detection arm to move against the bias of the spring in a direction toward the fork. The rotary sensor may detect a change in angular position of the load detection arm and generate corresponding rotational signals, which are indicative of the position of the load relative to a predefined location on the fork as the load moves along the fork.

The rotary sensor may comprise one of a rotary potentiometer or a rotary encoder hall-effect sensor.

In accordance with a second aspect, a method is provided for detecting a position of a load on a fork of a materials handling vehicle comprising: providing a sensor device comprising a pivotable load detection arm coupled to the fork and a rotary sensor coupled to the fork and engaged with the load detection arm. The method may further comprise moving a load along the fork and pivoting the load detection arm by the load as the load moves along the fork; detecting a change in angular position of the load detection arm via the rotary sensor, whereby the rotary sensor generates corresponding rotational signals; and determining the position of the load relative to a predefined location on the fork from the rotational signals as the load moves along the fork.

The load detection arm may be directly coupled to the rotary sensor.

The method may further comprise providing a sensor arm coupled to the rotary sensor.

The sensor arm may be in engagement with the load detection arm for angular movement with the load detection arm.

The method may further comprise providing a spring to bias the sensor arm in a direction toward the load detection arm such that the sensor arm engages the load detection arm.

The method may further comprise providing a spring for biasing the load detection arm outward away from the fork.

In accordance with a third aspect, a materials handling vehicle is provided comprising: a fork; a pivotable load detection arm coupled to the fork; a rotary sensor coupled to the fork and engaged with the load detection arm, the rotary sensor generating rotational signals as the load detection arm pivots relative to the fork; one or more memory devices for collectively storing executable instructions; one or more microprocessors in communication with the one or more memory devices, wherein the one or more microprocessors are collectively configured when executing the executable instructions to: receive the rotational signals from the rotary sensor as the load detection arm pivots when engaged by a load moving along the fork; and determine, from the rotational signals, the position of the load on the fork relative to a predefined location on the fork as the load moves along the fork.

The one or more microprocessors may be collectively configured to determine two or more positions of the load on the fork relative to the predefined location on the fork as the load moves along the fork.

The one or more microprocessors may be collectively configured to enable operation of a traction motor on the vehicle only when the position of the load is in engagement with or within a predetermined distance from the predefined location on the fork.

A sensor arm may be coupled to the rotary sensor, with the sensor arm in engagement with the load detection arm for angular movement with the load detection arm.

The sensor arm may be spring biased in a direction toward the load detection arm such that the sensor arm engages the load detection arm.

The sensor arm may be fixed to the load detection arm.

A spring may be provided for biasing the load detection arm outward away from the fork. In accordance with a fourth aspect, a sensor device on a fork of a materials handling vehicle is provided. The sensor device may comprise: a pivotable load detection arm coupled to the fork and a rotary sensor. The load detection arm may comprise a main body comprising a lower end near a heel of the fork and an upper end at an opposite end of the main body from the lower end. The upper end of the main body of the load detection arm may comprise an upper stop for limiting rotation of the load detection arm toward a tip of the fork and the lower end of the main body of the load detection arm may comprise a slot for limiting rotation of the load detection arm away from the tip of the fork. The rotary sensor may be coupled to the fork and associated with the load detection arm. The rotary sensor may generate rotational signals as the load detection arm pivots relative to the fork in response to a load making contact with and causing movement of the load detection arm as the load moves along the fork, wherein linear movement of the load along the fork after making contact with the load detection arm is capable of being determined based on the rotational signals generated by the rotary sensor.

The load detection arm may be directly coupled to the rotary sensor.

A sensor arm may be coupled to the rotary sensor, with the sensor arm in engagement with the load detection arm for angular movement with the load detection arm.

The sensor device may further comprise: a mount coupled to the fork, whereby the pivotable load detection arm and the rotary sensor may be coupled to an outer side portion of the fork via the mount. An upper limit element may be coupled to the mount. The upper stop on the main body of the load detection arm may engage the upper limit element to limit rotation of the load detection arm toward the tip of the fork.

The sensor device may further comprise a lower limit element coupled to the mount, wherein the slot on the main body of the load detection arm may comprise an open slot and rotation of the load detection arm away from the tip of the fork stops when a portion of the main body of the load detection arm defining an end of the open slot engages the lower limit element. A cover may be coupled to the mount to enclose the load detection arm and the rotary sensor.

The main body of the load detection arm may be hollow and further comprising: a spring for biasing the load detection arm outward; and as the load is received and moves along the fork in a direction toward the heel of the fork, the load may engage with the load detection arm causing the load detection arm to move against the bias of the spring in a direction toward the heel of the fork. The rotary sensor may detect a change in angular position of the load detection arm and generate corresponding rotational signals which are indicative of the position of the load relative to a predefined location as the load moves along the fork.

The rotary sensor may comprise one of a rotary potentiometer or a rotary encoder hall-effect sensor.

In accordance with a fifth aspect, a method may be provided for detecting a position of a load on a fork of a materials handling vehicle comprising: providing a sensor device comprising: a pivotable load detection arm coupled to the fork, the load detection arm comprising a main body comprising a lower end near a heel of the fork and an upper end at an opposite end of the main body from the lower end, the upper end comprising an upper stop for limiting rotation of the load detection arm toward a tip of the fork and the lower end of the main body of the load detection arm comprises a slot for limiting rotation of the load detection arm away from the tip of the fork; and a rotary sensor coupled to the fork and associated with the load detection arm. The method may further comprise moving a load along the fork; pivoting the load detection arm by the load as the load engages the load detection arm and moves along the fork; detecting a change in angular position of the load detection arm via the rotary sensor, whereby the rotary sensor generates corresponding rotational signals; and determining the position of the load relative to a predefined location from the rotational signals as the load moves along the fork while engaged with the load detection arm.

In accordance with a sixth aspect, a materials handling vehicle is provided comprising: a fork; a pivotable load detection arm coupled to the fork; a rotary sensor coupled to the fork, the rotary sensor generating rotational signals as the load detection arm pivots relative to the fork; one or more memory devices for collectively storing executable instructions; one or more microprocessors in communication with the one or more memory devices, wherein the one or more microprocessors are collectively configured when executing the executable instructions to: receive the rotational signals from the rotary sensor; and enable or disable operation of one or more vehicle functions based on the rotational signals.

The one or more microprocessors may be collectively configured to: determine, from the rotational signals, the position of a load along the fork when the load is in contact with the load detection arm; enable operation of one or more of the traction motor or a hydraulic motor to effect lift of the fork when the position of the load is within a first enablement threshold relative to a predefined location; and at least one of: disable operation of at least one of the traction motor or the hydraulic motor to effect lift of the fork when the position of the load is greater than a second enablement threshold relative to the predefined location; or enable operation of an alert device when the position of the load is greater than the second enablement threshold relative to the predefined location; wherein the second enablement threshold is greater than the first enablement threshold. The one or more vehicle functions may comprise operation of the traction motor; operation of the hydraulic motor; and/or operation of the alert device as well as operation of any other devices on the vehicle.

The one or more microprocessors may be collectively configured to: disable one of the traction motor or the hydraulic motor when the position of the load is greater than the second enablement threshold relative to the predefined location and disable the other one of the traction motor or the hydraulic motor when the position of the load is greater than a third enablement threshold relative to the predefined location, the third enablement threshold may be greater than the second enablement threshold.

In accordance with a seventh aspect, a materials handling vehicle is provided comprising: a power unit comprising a frame, at least one driven wheel coupled to the frame, a traction motor for driving the driven wheel, and a motion sensor associated with the traction motor for generating motion signals; a fork; a pivotable load detection arm coupled to the fork; a rotary sensor coupled to the fork and engaged with the load detection arm, the rotary sensor generating rotational signals as the load detection arm pivots relative to the fork; and one or more memory devices for collectively storing executable instructions, the one or more microprocessors in communication with the one or more memory devices. The one or more microprocessors may be collectively configured when executing the executable instructions to: control operation of the driven wheel; receive the motion signals from the motion sensor; receive the rotational signals from the rotary sensor; and enable one or more vehicle functions based on at least one of the motion signals or the rotational signals.

The one or more microprocessors may be collectively configured to: determine from the motion signals the distance traveled by the power unit; determine, from the rotational signals, the position of the load detection arm, and during operation of the vehicle to pick a load with the fork, activating an alert device when the distance traveled by the power unit in a forks first direction is greater than a predefined distance and the position of the load detection arm, as determined by the rotational signals, has not moved past a predetermined angular position.

The materials handling vehicle may further comprise: a load handling assembly comprising: a mast assembly coupled to the power unit; a carriage assembly movably coupled to the mast assembly for vertical movement relative to and with the mast assembly; a fork carriage mechanism to which the fork is mounted; a reach mechanism coupled to the carriage assembly and the fork carriage mechanism for effecting movement of the fork carriage mechanism and the fork toward and away from the carriage assembly and the mast assembly; and a reach assembly sensor for generating signals indicative of the distance that the fork carriage mechanism and the fork move relative to the mast assembly. The one or more microprocessors may be collectively configured to: determine from the signals generated by the reach assembly sensor the distance that the fork travels away from the mast assembly; and during operation of the vehicle to pick a load with the fork, activating the alert device when the combined distance traveled by the power unit in the forks first direction and the distance the fork travels away from the mast assembly is greater than a predefined distance and the position of the load detection arm, as determined by the rotational signals, has not moved past a predetermined angular position as it rotates away from a tip of the fork.

The one or more microprocessors may be collectively configured to: determine from the motion signals the distance traveled by the power unit; determine, from the rotational signals, the position of the load detection arm, and during operation of the vehicle to drop off a load on the fork, activating an alert device when the distance traveled by the power unit in a power unit first direction is greater than a predefined distance and the position of the load detection arm, as determined by the rotational signals, has not changed.

The materials handling vehicle may further comprise: a load handling assembly comprising: a mast assembly coupled to the power unit; a carriage assembly movably coupled to the mast assembly for vertical movement relative to and with the mast assembly; a fork carriage mechanism to which the fork is mounted; a reach mechanism coupled to the carriage assembly and the fork carriage mechanism for effecting movement of the fork carriage mechanism and the fork toward and away from the carriage assembly and the mast assembly; and a reach assembly sensor for generating signals indicative of the distance that the fork carriage mechanism and the fork move relative to the mast assembly. The one or more microprocessors may be collectively configured to: determine from the signals generated by the reach assembly sensor the distance that the fork travels toward the mast assembly; and during operation of the vehicle to drop off a load on the fork, activating the alert device when the combined distance traveled by the power unit in a power unit first direction and the distance the fork travels toward the mast assembly is greater than a predefined distance and the position of the load detection arm, as determined by the rotational signals, has not changed.

The one or more microprocessors may be collectively configured to determine more than four positions of a load on the fork relative to the predefined location as the load moves along the fork.

### BRIEF DESCRIPTION OF THE SEVERAL VIEWS OF THE DRAWINGS

FIG. 1 is an example vehicle in which a sensor device described herein may be used;

FIG. 2 illustrates a fork carriage apparatus of the vehicle of FIG. 1;

FIG. 3 illustrates a processing device of the vehicle of FIG. 1;

FIG. 4 illustrates forks each including a sensor device described herein;

FIGS. 5 and 6 illustrate a sensor device in accordance with a first embodiment;

FIGS. 7-9 illustrates various positions of a load relative to a sensor device on a fork;

FIG. 10 illustrates a sensor device in accordance with a second embodiment;

FIG. 11 is a flowchart of an example method for detecting a position of a load on a fork of a materials handling vehicle;

FIG. 12 is a perspective view of the sensor device coupled to a mount with a corresponding fork not shown;

FIGS. 13 and 14 illustrate a sensor device in accordance with a further embodiment;

FIG. 15 is a flowchart of an example control algorithm or method for enabling and/or disabling operation of one or more vehicle functions based on rotational signals from a rotary sensor;

FIG. 16 is a flowchart of an example control algorithm or method for activating an alert device when, after a pick operation has been initiated, a distance traveled by a power unit in a forks first direction is greater than a predefined distance and the position of a load detection arm(s) has not moved past a predetermined angular position;

FIG. 17 illustrates a power unit at an initial position prior to a pick operation being initiated;

FIG. 18 illustrates a power unit moved from the position in FIG. 17, after a pick operation has been initiated, a distance greater than a predefined distance while a position of a load detection arm(s) did not move past a predetermined angular position during the pick operation such that an alert device has been activated;

FIG. 19 is a flowchart of an example control algorithm or method for activating an alert device when, after a pick operation has been initiated, a combined distance traveled by the power unit in a forks first direction and the distance the forks travel in a direction away from the mast assembly is greater than a predefined distance PD₂ and the position of the load detection arm(s), as determined by the rotational signals, has not moved past a predetermined angular position during the pick operation.

FIG. 20 illustrates a power unit at an initial position prior to a pick operation being initiated;

FIG. 21 illustrates the power unit moving, after a pick operation has been initiated, a first distance FD₁ and the forks being extended away from the mast assembly by a second distance SD₁ such that the summation of the first and second distances FD₁ and SD₁ is greater than a predefined distance PD₂ and the position of the load detection arm(s) has not moved past a predetermined angular position;

FIG. 22 is a flowchart of an example control algorithm or method for activating an alert device when, during an operation to drop off a load L from the fork(s), a distance traveled by the power unit in a power unit first direction is greater than a predefined distance PD₃ and the position of the load detection arm(s) has not changed;

FIG. 23 illustrates a power unit at an initial position prior to a drop off operation being initiated;

FIG. 24 illustrates the power unit having moved, after a drop off operation has been initiated, a distance greater than a predefined distance PD₃ and the position of the load detection arm(s) has not changed;

FIG. 25 is a flowchart of an example control algorithm or method for activating an alert device when, after a drop off operation has been initiated, a combined distance traveled by the power unit in a power unit first direction and the distance the forks travel in a direction toward the mast assembly is greater than a predefined distance PD₄ and the position of the load detection arm(s) has not changed;

FIG. 26 illustrates a power unit at an initial position prior to a drop off operation being initiated with the forks extending away from the mast assembly;

FIG. 27 illustrates the power unit having moved a first distance FD₂ greater than the predefined distance PD₄ after the drop off operation has been initiated while the position of the fork(s) has not changed;

FIG. 28 illustrates a top view of a fork and further illustrates first, second and third enablement thresholds.

### DETAILED DESCRIPTION

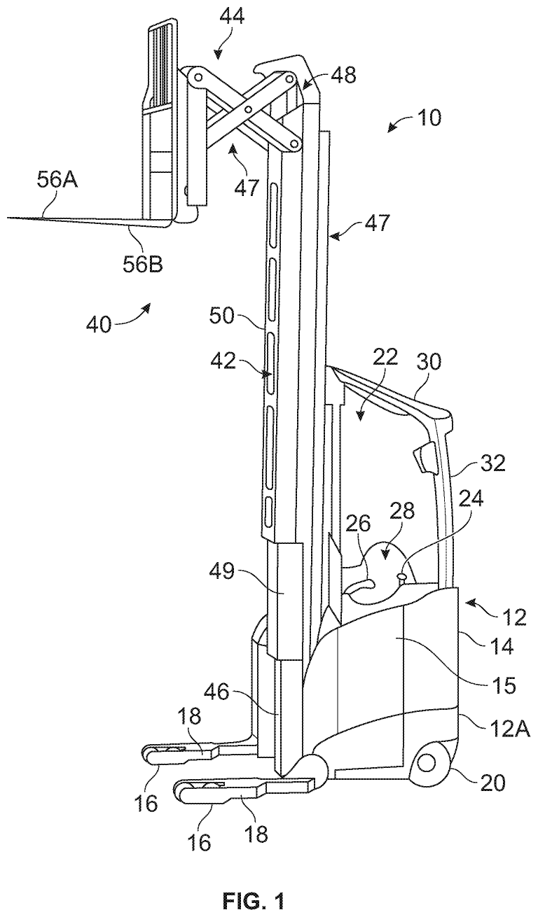

In the following detailed description of the preferred embodiments, reference is made to the accompanying drawings that form a part hereof, and in which is shown by way of illustration, and not by way of limitation, specific preferred embodiments in which the subject matter of this disclosure may be practiced. It is to be understood that other embodiments may be utilized and that changes may be made without departing from the spirit and scope of the present disclosure. Referring now to FIG. 1, a materials handling vehicle 10 (hereinafter “vehicle”) is shown. While the present subject matter is described herein with reference to the illustrated vehicle 10, which comprises a manually driven forklift truck, it will be apparent to those skilled in the art that the present subject matter may be used in a variety of other types of materials handling vehicles including autonomous and semi-autonomous materials handling vehicles.

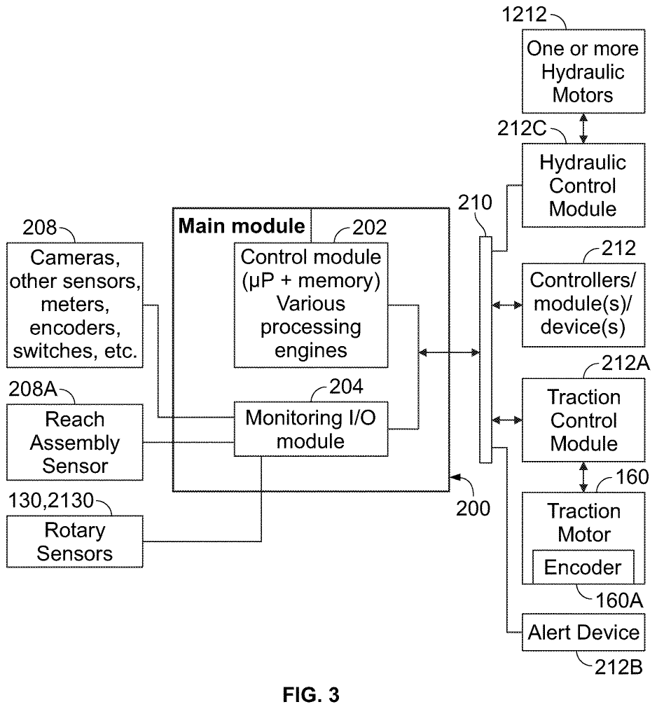

The vehicle 10 includes a main body or power unit 12, which includes a frame 14 defining a main structural component of the vehicle 10 and which houses a battery 15, which supplies power to the vehicle 10, such as a traction motor 160, see FIG. 3, and to one or more hydraulic motors 1212, see FIG. 3.

The vehicle 10 further comprises a pair of fork-side support wheels 16 coupled to first and second outriggers 18, a driven and steered wheel 20 mounted near a first corner at a rear 12A of the power unit 12, and a caster wheel (not shown) mounted to a second corner at the rear 12A of the power unit 12. The traction motor 160 drives the steered wheel 20 and together the traction motor 160 and the steered wheel 20 define a drive mechanism for effecting movement of the vehicle 10 across a floor surface.

An operator's compartment 22 may be located within the power unit 12 for receiving an operator driving the vehicle 10. A tiller knob 24 may be provided within the operator's compartment 22 for controlling steering of the vehicle 10. The speed and direction of movement (forward or reverse) of the vehicle 10 may be controlled by the operator via a multi-function control handle 26 provided adjacent to an operator seat 28, which control handle 26 may control one or more other vehicle functions as will be appreciated by those having ordinary skill in the art. The vehicle 10 further includes an overhead guard 30 including a vertical support structure 32 affixed to the vehicle frame 14. The vehicle may be controlled as an autonomous vehicle even if an operator's compartment is provided with a tiller knob 24 and multi-function control handle 26. It is also contemplated that an operator's compartment may not be incorporated into the vehicle if it functions solely as an autonomous vehicle.

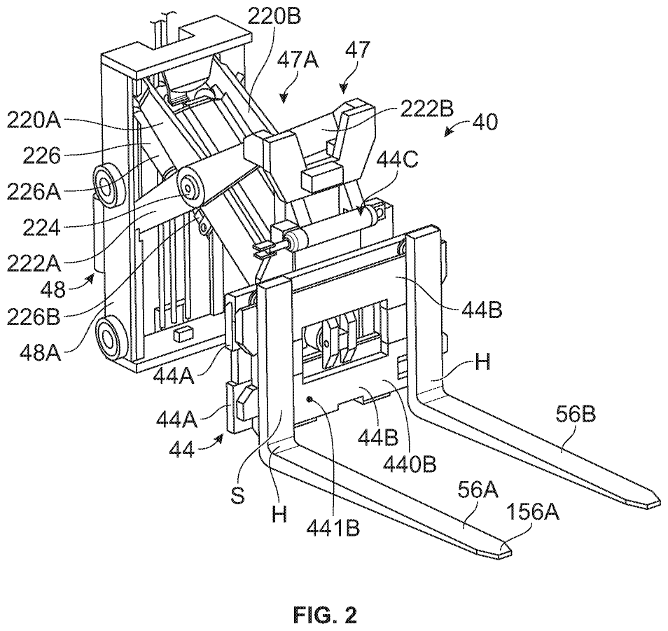

A load handling assembly of the vehicle 10 includes, generally, a mast assembly 42 and a fork carriage apparatus 40 comprising a fork carriage mechanism 44 to which first and second forks 56A and 56B are mounted, see FIGS. 1 and 2. The mast assembly 42 is positioned between the outriggers 18 and includes a fixed mast member 46 affixed to the frame 14, and nested first and second movable mast members 49, 50. It is noted that the mast assembly 42 may include additional or fewer movable mast members than the two shown in FIG. 1, i.e., the first and second movable mast members 49, 50. The one or more hydraulic motor(s) supply pressurized hydraulic fluid to several different systems, such as one or more hydraulic cylinders (not shown) for effecting generally vertical movement of movable mast members 49, 50 of the mast assembly 42 relative to the fixed mast member 46 and generally vertical movement of the fork carriage apparatus 40 relative to the mast assembly 42 as well as cylinders of a reach mechanism 47, discussed below. The mast assembly 42 may be configured as the monomast described in U.S. Pat. No. 8,714,311 to Steven C. Billger et al., granted on May 6, 2014 and assigned to the applicant, Crown Equipment Corporation, the entire disclosure of which is hereby incorporated by reference herein.

The fork carriage mechanism 44 may be mounted to the reach mechanism 47 which, in turn, is mounted to a carriage assembly 48. The reach mechanism 47 and the carriage assembly 48 also form part of the carriage apparatus 40. The carriage assembly 48 may be movably coupled to the second movable mast member 50 for movement relative to and with the second movable mast member 50. The reach mechanism 47 comprises a pantograph or scissors structure 47A, which effects movement of the fork carriage mechanism 44 and the first and second forks 56A and 56B toward and away from the carriage assembly 48 and the mast assembly 42.

The pantograph or scissors structure may comprise first and second inner arms 220A and 220B and first and second outer arms 222A and 222B, see FIG. 2. The first and second inner arms 220A and 220B include first ends (not shown) pivotally coupled to the fork carriage mechanism 44. A roller (not shown) is coupled to each of second ends of the first and second inner arms 220A and 220B, which rollers engage and move along vertically extending tracks (not shown) formed in a main unit 48A of the carriage assembly 48. The first and second outer arms 222A and 222B includes first ends (not shown) pivotally coupled to the fork carriage mechanism 44 and second ends (not shown) pivotally coupled to the main unit 48A of the carriage assembly 48.

The first and second inner arms 220A and 220B are coupled to the first and second outer arms 222A and 222B at pivot connections 224, only one is shown, see FIG. 2. First and second piston/cylinder assemblies 226, only one is shown, see FIG. 2, are provided for effecting movement of the reach mechanism 47 so as to move the fork carriage mechanism 44 toward and away from the carriage assembly 48. The first piston/cylinder assembly 226 is coupled at its cylinder 226A to the carriage assembly main unit 48A and at its piston 226B to the first inner arm 220A. The second piston/cylinder assembly, not shown, is coupled at its cylinder to the carriage assembly main unit 48A and at its piston to the second inner arm 220B. Movement of the pistons 226B out of the cylinders 226A causes the first and second inner and outer arms 220A, 220B, 222A and 222B to move the fork carriage mechanism 44 away from the carriage assembly 48. Movement of the pistons 226B into the cylinders 226A causes the first and second inner and outer arms 220A, 220B, 222A and 222B to move the fork carriage mechanism 44 toward the carriage assembly 48.

A reach assembly sensor 208A (shown only in FIG. 3), which may comprise a rotary encoder, may be coupled to the second end of the first inner arm 220A of the reach mechanism 47 and the carriage assembly main unit 48A so as to sense relative movement between the reach mechanism 47 and the carriage assembly 48, i.e., so as to sense the position and speed of movement of the reach mechanism 47 relative to the carriage assembly 48. Signals generated by the reach assembly sensor 208A may define the location or position of the first inner arm 220A relative to a reference point on the main unit 48A of the carriage assembly 48. Once the position of the first arm 220A along the main unit 48A of the carriage assembly 48 is known and since the length of the first arm 220A is constant, the pythagorean theorem or trigonometric functions can be used to determine the distance extending between the carriage assembly main unit 48A and the fork carriage mechanism 44. Since the carriage assembly main unit 48A is attached to and moves along the mast assembly 42 and the forks 56A and 56B are mounted to the fork carriage mechanism 44, the distance between the carriage assembly main unit 48A and the fork carriage mechanism 44 may be considered equal to the distance between the mast assembly 42 and the forks 56A and 56B. Hence, the signals generated by the reach assembly sensor 208A are indicative of the distance traveled by the forks 56A and 56B toward and away from the mast assembly 42, including the distance the forks 56A and 56B are located away from the mast assembly 42.

An alternative reach assembly sensor (not shown) comprises a rotary encoder draw wire assembly, where a rotary encoder is mounted to the main unit 48A of the carriage assembly 48 and the draw wire extends from the rotary encoder across the reach mechanism 47 and is coupled to the fork carriage mechanism 44. A spring may be provided to recoil the wire as the fork carriage mechanism 44 moves toward the carriage assembly 48. The linear distance the fork carriage mechanism 44 is located from the main unit 48A of the carriage assembly 48 is calculated using the pulses or signals from the rotary encoder, which encoder pulses are converted to a linear distance, such as by the rotary encoder itself or by a vehicle control module 202, discussed further herein.

The reach mechanism 47 may be constructed in the manner described in U.S. Pat. No. 9,290,366, the disclosure of which is incorporated herein by reference.

The fork carriage mechanism 44 may comprise a carriage support structure 44A and a fork carriage frame 44B. The forks 56A and 56B are mounted to the fork carriage frame 44B. The frame 44B is coupled to the carriage support structure 44A for lateral and pivotable movement relative to the support structure 44A. A side-shift piston/cylinder unit 44C is mounted to the carriage support structure 44A and the fork carriage frame 44B, so as to effect lateral movement of the fork carriage frame 44B relative to the carriage support structure 44A.

The vehicle 10 further comprises a processing device 200, see FIG. 3. The processing device 200 may comprise a special purpose, particular hardware computer, such as a device that mounts to or is otherwise integrated with the vehicle 10. The computer of the processing device 200 may comprise data processing circuitry (illustrated generally as the vehicle control module 202) comprising one or more electronic processors (μP) coupled to one or more memory devices for implementing executable instructions, including the relevant processes, or aspects thereof, as set out and described more fully herein. The one or more memory devices may comprise memory that stores processing or executable instructions, as well as memory for data storage, e.g., to implement one or more databases, data stores, registers, arrays, etc. Still further, the processing device 200 may comprise a monitoring input/output (I/O) module 204 to communicate with the control module 202 and one or more peripheral devices mounted to or otherwise associated with the vehicle 10, including one or more cameras, sensors, such as the reach assembly sensor 208A, discussed above, and a rotary sensor 130, 2130 to be discussed below, meters, encoders, switches, etc. (those not separately labeled are collectively represented by reference numeral 208). The processing device 200 is coupled to and/or communicates with other vehicle system components via a suitable vehicle network system 210. The vehicle network system 210 may comprise at least one network, bus, or other communications capability or combination thereof that allows electronic components of the vehicle 10 to communicate with each other. As an example, the vehicle network system 210 may comprise a controller area network (CAN) bus, ZigBee, Bluetooth®, Local Interconnect Network (LIN), time-triggered data-bus protocol (TTP), RS422 bus, Ethernet, universal serial bus (USB), other suitable communications technology, or combinations thereof. Utilization of the vehicle network system 210 enables seamless integration of the components of the vehicle 10 with the processing device 200, and in particular, the control module 202. By way of example, the vehicle network system 210 enables communication between the control module 202 and one or more vehicle components, such as a traction control module 212A, a steering control module, a hydraulic control module 212C, other controllers, other modules, devices, bus-enabled sensors, displays, such as an alert device 212B, lights, light bars, sound generating devices, etc. (those not separately labeled are designated generally by reference numeral 212).

The traction control module 212A may comprise one or more electronic processors (μP), one or more memory devices storing executable program code, and/or other circuitry configured to perform its individual functions, which include controlling the operation of the traction control motor 160, such as controlling torque, speed, and/or acceleration of the traction control motor 160.

The hydraulic control module 212C may comprise one or more electronic processors (MP), one or more memory devices storing executable program code, and/or other circuitry configured to perform its individual functions, which include controlling the operation of one or more hydraulic motors 1212 for providing pressurized hydraulic fluid to hydraulic cylinders (not shown) of the mast assembly 42 and fork carriage apparatus 40 and other hydraulic devices on the vehicle. Appropriate electronically or manually controlled valves may be provided between the one or more hydraulic motors 1212 and the hydraulic cylinders and other hydraulic devices as is known in the art. The electronic hydraulic valves may be controlled by the hydraulic control module 212C or directly by the control module 202.

A motion sensor defined by a rotary encoder 160A may be coupled to an output shaft of the traction motor 160 to generate motion signals indicative of the speed and direction of rotation of the traction motor 160. The motion signals may be provided to the traction control module 212A, which determines the direction and speed of rotation of the traction motor 160 from those signals. The traction control module 212A then forwards the traction motor rotational speed and direction information to the control module 202 via the vehicle network system 210, whereby the control module 202 determines the speed of, direction of travel of and distance traveled by the power unit 12 from the traction motor rotational speed and direction information. The distance traveled by the power unit 12 may be determined from the velocity or speed information via integration, a look up table or other known method.

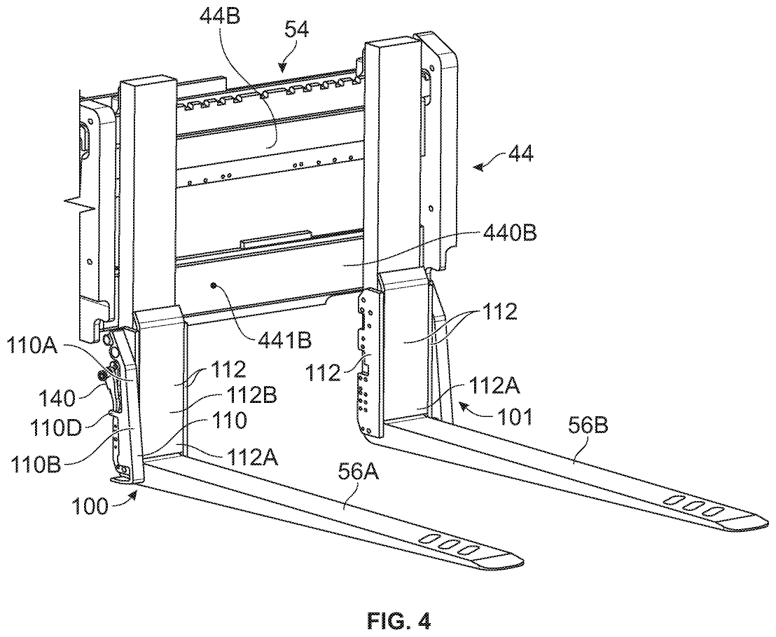

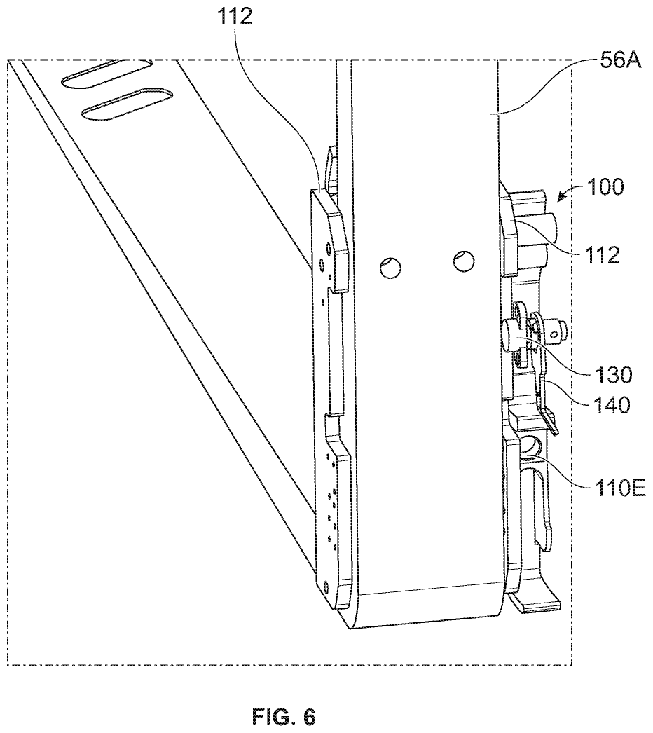

In order to determine when a load L, such as a pallet, has been fully loaded or positioned on the forks 56A and 56B, a sensor device 100 and 101 (the sensor devices 100 and 101 are not illustrated in FIGS. 1 and 2) formed in accordance with a first example is associated with each of the first and second forks 56A and 56B, see FIGS. 4-6. Since each sensor device 100 and 101 on the first and second forks 56A and 56B may be the same, only the sensor device 100 on the first fork 56A will be described in detail herein. Hence, the sensor device 101 on the second fork 56B may be constructed in the same manner as the sensor device 100 on the first fork 56A.

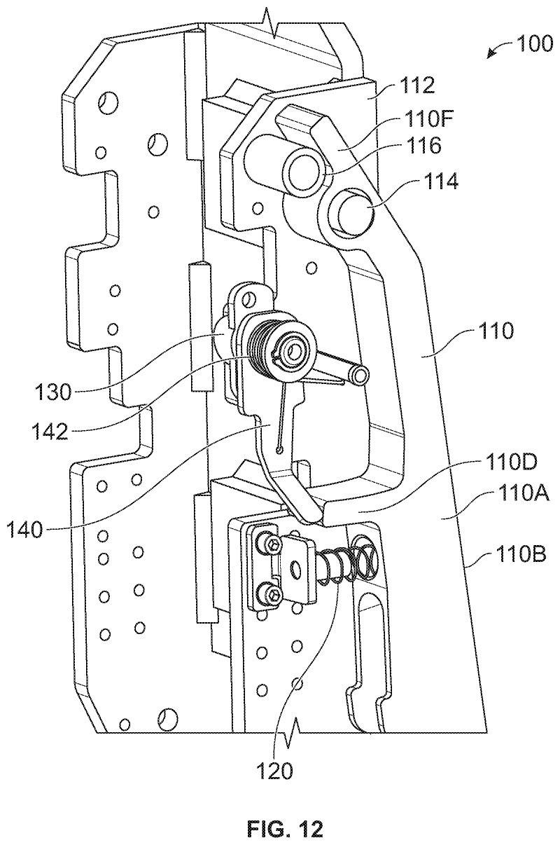

The sensor device 100 comprises a pivotable load detection arm 110, which is coupled to the fork 56A. A mount 112 may be welded, bolted or otherwise coupled to the fork 56A. In the illustrated embodiment, the mount 112 is generally U-shaped so as to cover front and side portions of a lower part of a shank S of the fork 56A, see FIGS. 2, 4-6 and 12. The pivotable load detection arm 110 may be pivotably or rotatably coupled to the mount 112 via a shaft 114 such that the detection arm 110 rotates about the shaft 114 relative to the fork 56A. Hence, the load detection arm 110 is coupled to the fork 56A via the mount 112 and the shaft 114. It is also contemplated that the pivotable load detection arm 110 may be directly coupled to the fork 56A via a shaft or similar element.

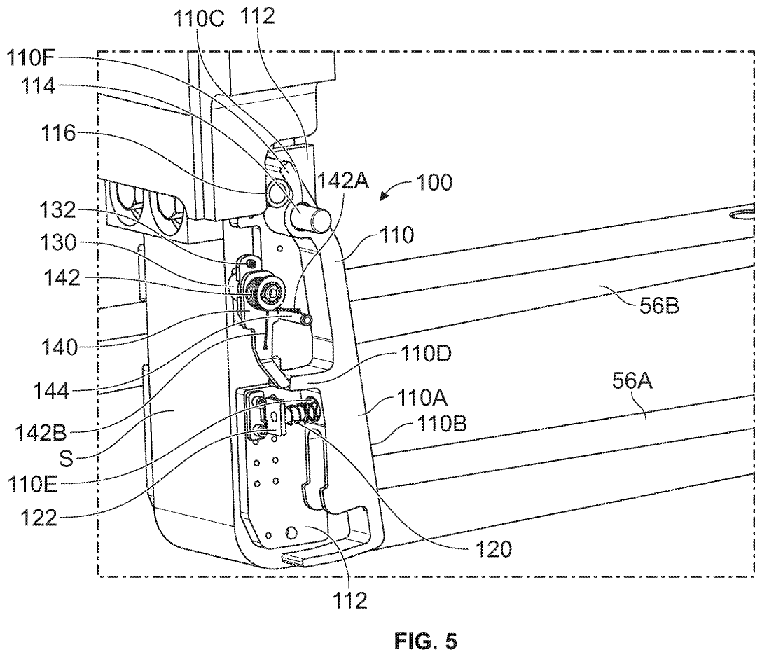

The load detection arm 110 may comprise a main body 110A having an outer front surface 110B. The main body 110A may comprise a bore 110C for receiving the shaft 114 and a contact arm 110D extending in a direction away from the outer front surface 110B. The shaft 114 may be coupled to the mount 112 or directly to the fork 56A. A compression spring 120, shown only in FIG. 5, contacts and extends from a base 122 fixed to the mount 112 into a recess 110E in the load detection arm 110 to engage and bias the load detection arm 110 in a direction toward a tip 156A of the fork 56A or away from the heel H of the fork 56A. A torsional or any other spring could be used in place of the compression spring 120. The main body 110A comprises an upper stop 110F, which engages with a limit shaft 116 fixed to the mount 112 or the fork 56A. The upper stop 110F engages with the limit shaft 116 to stop or limit movement of the load detection arm 110 due to a force applied to the load detection arm 110 by the spring 120.

A rotary sensor 130 may be coupled to the mount 112 via one or more bolts 132, see FIG. 5, so as to couple the sensor 130 to the fork 56A. The rotary sensor 130 may also be fastened directly to the fork 56A. A sensor arm 140 may be coupled to the rotary sensor 130 such that angular movement of the sensor arm 140 is detected by the rotary sensor 130. In the example of FIGS. 4-6, the sensor arm 140 engages with the contact arm 110D of the load detection arm 110 such that angular movement of the load detection arm 110 causes corresponding angular movement of the sensor arm 140. The sensor arm 140 may be fixed to the contact arm 110D via a fastener, welding or may be integral with the contact arm 110D. A torsional spring 142 may be provided having a leg 142A which engages with a pin 144 fixed to the mount 112 and a further leg 142B that engages with the sensor arm 140. The spring 142 biasing the sensor arm 140 toward the contact arm 110D of the load detection arm 110 such that the sensor arm 140 always contacts or engages the load detection arm 110. Hence, the rotary sensor 130 detects the angular position of the load detection arm 110 via the sensor arm 140 as angular movement of the load detection arm 110 is transferred to the rotary sensor 130 via the sensor arm 140. The rotary sensor 130 may comprise a rotary potentiometer, a rotary encoder hall-effect sensor, or any equivalent rotary or angle sensor.

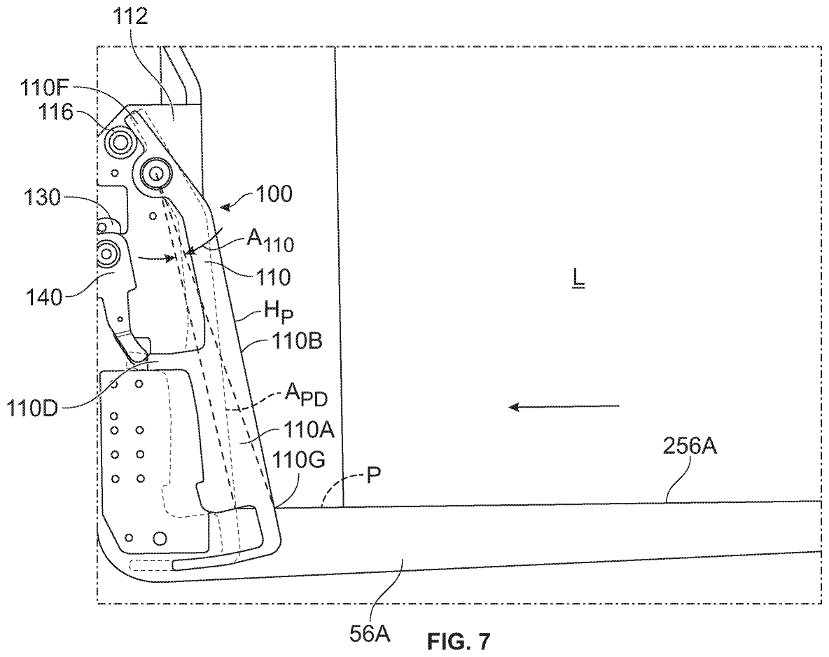

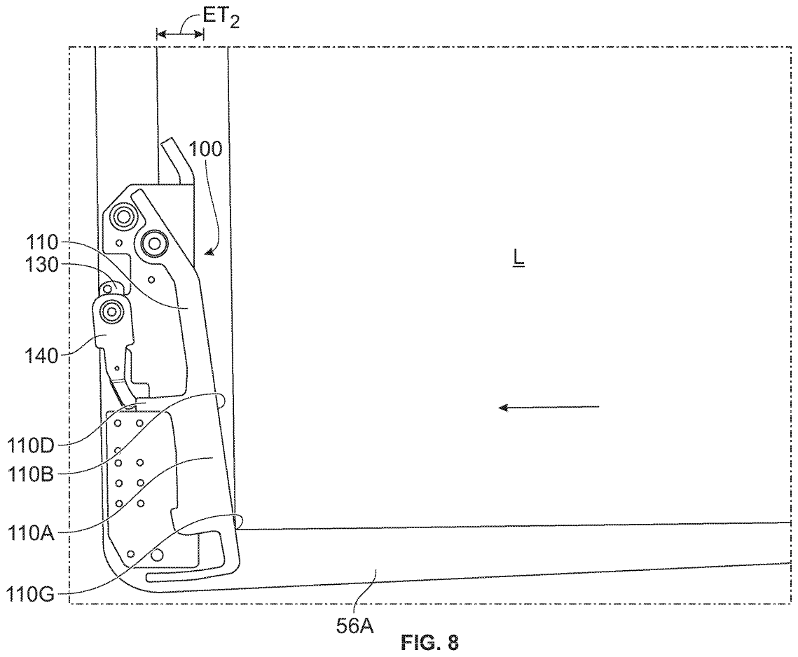

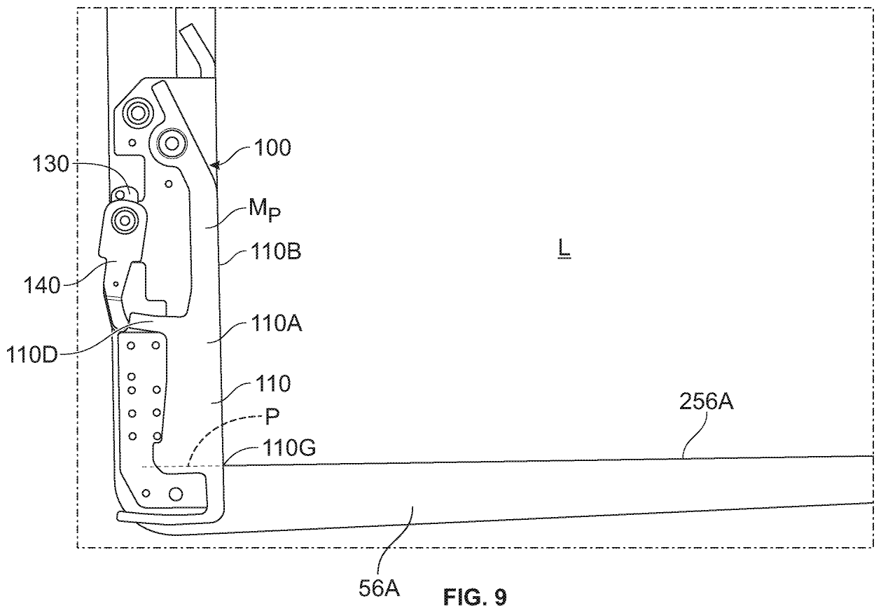

As the load moves along the forks 56A and 56B, i.e., the forks enter into corresponding openings or slots within a pallet, or the load L is moved onto and along the forks 56A and 56B, the load L moves in a direction toward the sensor device 100 and the heel H of the fork 56A, see the arrow in FIGS. 7 and 8. FIG. 7 illustrates the load L just before it engages with the load detection arm 110 of the sensor device 100 of the first fork 56A. Hence, in FIG. 7, the load detection arm 110 is in its home position, i.e., maximum angular position, where the spring 120 biases the load detection arm 110 to its outmost position where the upper stop 110F of the arm 110 engages with the limit shaft 116. FIG. 8 illustrates the load L after it has engaged and caused some rotational movement of the load detection arm 110 in a clockwise direction as viewed in the FIG. 8. FIG. 9 illustrates the load L after it has engaged and caused rotational movement of the load detection arm 110 to its fully inwardly rotated or fully engaged position, i.e., minimum angular position. In this state, the load L is in engagement with a predefined location on the fork 56A, e.g., the heel H or shank S of the fork 56A, or, if a mount 112 is provided, with the mount 112 coupled to the fork 56A, such that the load L is unable to cause further inward movement or rotation of the load detection arm 110 toward the shank S of the fork 56A.

As the load detection arm 110 is caused to rotate or pivot relative to the fork 56A by the load L as the load L moves along the fork 56A and makes contact with and causes movement of the load detection arm 110, the contact arm 110D on the load detection arm 110 acts against the sensor arm 140 causing angular movement of the sensor arm 140. The rotary sensor 130 detects the angular movement of the sensor arm 140, which corresponds to the angular movement of the load detection arm 110, and generates rotational signals corresponding to the angular movement of the load detection arm 110. The rotational signals generated by the sensor 130 may be received by the control module 202. A look up table may be stored in a memory device associated with the control module 202. The control module 202 may access the lookup table and use as an input into the lookup table an angle of the load detection arm 110, as measured by the rotary sensor 130, and receive as an output from the lookup table a distance a lower point 110G on the outer front surface 110B of the main body 110A of the load detection arm 110 is from the predefined location on the fork 56A, e.g., the heel H or shank S of the fork 56A or a point 112A on the lower front surface of the mount 112, see FIG. 4. The lower point 110G on the load detection arm 110 occurs generally where the outer front surface 110B of the main body 110A of the load detection arm 110 intersects a plane P, which includes an upper surface 256A of the fork 56A. Hence, the location of the lower point 110G may vary over a small range along the outer front surface 110B of the main body 110A of the load detection arm 110 based on the angle of rotation of the load detection arm 110. The lower point 110G on the load detection arm 110 may be directly adjacent to a portion of the load L making contact with the load detection arm 110, see FIG. 8. Hence, the location or position of the lower point 110G of the load detection arm 110 relative to the fork 56A is substantially equal to the location or position of the portion of the load L making contact with the load detection arm 110 relative to the heel H or shank S of the fork 56A or the point 112A on the lower front surface of the mount 112. Further, the distance the lower point 110G of the load detection arm 110 is from the heel H or shank S of the fork 56A or the point 112A on the mount 112 is substantially equal to the distance the portion of the load Lis from the heel H or shank S of the fork 56A or the point 112A on the mount 112. Accordingly, linear movement of the load along the fork 56A after making contact with the load detection arm 110 is capable of being determined based on the rotational signals generated by the rotary sensor 130.

The lookup table may be determined empirically/manually by measuring and storing the location or position of the lower point 110G of the load detection arm 110 relative to the fork 56A and/or the distance the lower point 110G of the load detection arm 110 is from the heel H or shank S of the fork 56A or the point 112A on the mount 112 for various angles sensed by the rotary sensor 130. It is also contemplated that the look up table may be generated via conventional modeling software. For example, the model would have knowledge of all dimensions of the load detection arm 110 and the fork 56A and the model could simulate moving the lower point 110G of the load detection arm 110 to various positions between the maximum angular position of the arm 110 illustrated in FIG. 7 to the minimum angular position of the arm 110 in FIG. 9 and extract angles for the load detection arm at each of those positions. It is further contemplated that instead of using a lookup table, an equation may be generated manually or via modelling, that is stored in the memory device that provides, based on an input of a rotational angle of the load detection arm, a distance the load L is from the heel or shank S of the fork 56A or the point 112A on the mount 112 and/or the location or position of the lower point 110G of the load detection arm 110 relative to the fork 56A, i.e., a location or position of the load L along the length of the fork 56A.

An advantage of the sensor device 100 is ease in calibration. To calibrate the sensor device 100, the load detection arm 110 may be allowed to move to its home position where the spring 120 biases the load detection arm 110 to its outmost angular position where the upper stop 110F of the arm 110 engages with the limit shaft 116, see FIG. 7. An input may be generated by a technician via a user interface screen on the vehicle to the control module 202 indicating the position of the load detection arm 110 at its home position so as to cause the control module 202 to take a reading from the rotary sensor 130. The value of the rotary sensor 130, i.e., the angle detected or measured, when the load detection arm 110 is at its home position is designated and stored as the home position angle. The load detection arm 110 may then be moved to its minimum angular position, see FIG. 9, where it has been fully rotated inwardly by the load L, such that the load L is in full engagement with the shank S of the fork 56A or the mount 112. A further input may be generated via the user interface screen to the control module 202 indicating the position of the load detection arm 110 at its fully inwardly rotated or fully engaged position so as to cause the control module 202 to take a reading from the rotary sensor 130. The value of the rotary sensor 130, i.e., the angle detected or measured, when the load detection arm 110 is at its fully engaged position is designated and stored as the fully engaged position angle. Hence, conventional modeling software, which would have knowledge of all dimensions of the load detection arm 110 and the fork 56A, could simulate movement of the lower point 110G of the load detection arm 110 along the fork 56A as the load detection arm 110 moves to various angular positions between the home position angle, see FIG. 7, to the minimum angular position of the arm 110 in FIG. 9, and define corresponding positions or locations of the lower point 110G of the load detection arm 110 relative to or along the fork 56A and/or the distance the lower point 110G of the load detection arm 110 is from the heel H or shank S of the fork 56A or the point 112A on the mount 112 for various angles sensed by the rotary sensor 130. After the sensor device 100 is calibrated, the control module 202 is able to determine multiple locations or positions of the load L along the fork 56A relative to the heel or shank S of the fork 56A or the point 112A on the mount 112, starting at a location or position where the load L first engages the load detection arm 110 and extending to where the load L contacts the heel or shank S of the fork 56A or the point 112A on the mount 112. Hence, the sensor device 100 is capable of sensing many, e.g., 2, 3, 4 or more than 4, spaced apart or different locations or positions, of the load L along the fork 56A relative to the heel or shank S of the fork 56A or the point 112A on the mount 112.

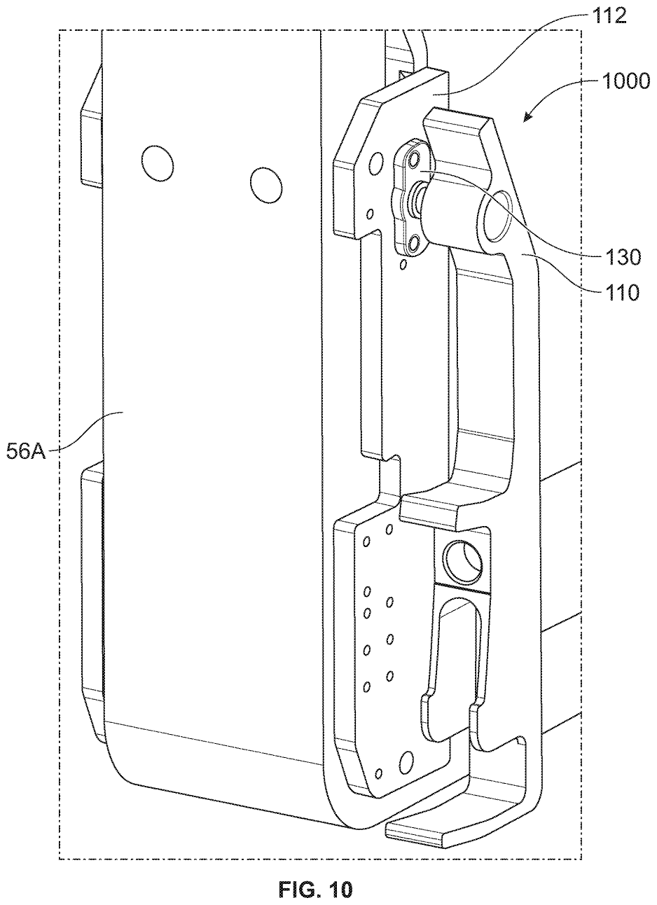

FIG. 10 illustrates a further embodiment of a sensor device 1000, where the load detection arm 110 is directly mounted and coupled with the rotary sensor 130 such that both share the same rotational axis. The load detection arm 110 and rotary sensor 130 may be mounted to a common shaft or the rotary sensor 130 may include a shaft to which the load detection arm 110 is mounted. In this embodiment, a sensor arm 140 is not required. The sensor device 1000 otherwise functions in the same manner as the sensor device 100.

The control module 202 may be programmed to prevent operation via the traction control module 212A of the traction motor 160 coupled to the driven steered wheel 20 unless a load L sensed by at least one of the sensor devices 100, 101, 1000 on the first and second forks 56A, 56B is either: (i) positioned against or in contact with the heels H or shanks S of the forks 56A, 56B or the points 112A on the mounts 112 coupled to the forks 56A, 56B; or (ii) within a first enablement threshold ET₁ or first predetermined distance, see FIG. 28, to a predefined location such as the heels H or shanks S of the forks 56A, 56B or the points 112A on the mounts 112. Option (i) or (ii) may be selected during a setup or calibration procedure of the vehicle. The control module 202 may also prevent operation of the one or more hydraulic motors effecting mast assembly movement or movement of the fork carriage apparatus 40 unless a load L sensed by at least one of the sensor devices 100, 101, 1000 on the first and second forks 56A, 56B is either: (i) positioned against or in contact with the heels H or shanks S of the forks 56A, 56B or the points 112A on the mounts 112 coupled to the forks 56A, 56B; or (ii) within a first enablement threshold ET₁ or first predetermined distance to a predefined location such as the heels H or shanks S of the forks 56A, 56B or the points 112A on the mounts 112. The first enablement threshold ET₁ includes the position of the load L against or in contact with the heels H or shanks S of the forks 56A, 56B or the points 112A on the mounts 112 coupled to the forks 56A, 56B.

It is also contemplated that the control module 202 may be programmed to allow for continued operation of the traction motor 160 and/or the one or more hydraulic motors 1212 if the load L shifts slightly in a direction away from the heels H or shanks S of the forks 56A, 56B or the points 112A on the mounts 112 coupled to the forks 56A, 56B during operation of the vehicle. The control module 202 may be programmed with a second enablement threshold ET₂ or a second predetermined distance, see FIG. 28, away from the predefined location such as the heels H or shanks S of the forks 56A, 56B or the points 112A on the mounts 112 coupled to the forks 56A, 56B to which the load L is allowed to move, and which distance is sensed by the sensor devices 100, 101, 1000, such that operation of the traction motor 160 and/or the one or more hydraulic motors 1212 are allowed to continue as long as the load L stays within the second enablement threshold ET₂ or second predetermined distance from the predefined location such as the heels H or shanks S of both forks 56A, 56B or the points 112A on the mounts 112. However, once the load L has moved beyond that second enablement threshold ET₂ or the second predetermined distance on either or both of the first fork 56A or the second fork 56B, the control module 202 may be programmed to discontinue operation of the traction motor 160 and/or the one or more hydraulic motors 1212. The second enablement threshold or second predetermined distance is greater than the first enablement threshold or first predetermined distance.

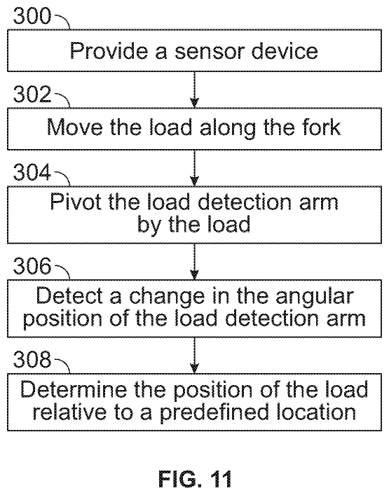

FIG. 11 is a flowchart of an example control algorithm or method for detecting a position of a load L on a fork 56A or 56B of a materials handling vehicle 10. In step 300, a sensor device 100, 101, 1000 is provided comprising: a pivotable load detection arm 110 coupled to the fork 56A or 56B; and a rotary sensor 130 coupled to the fork and engaged with the load detection arm 110. In step 302, the load L is moved along the fork 56A or 56B. In step 304, the load detection arm 110 is pivoted or rotated by the load L as the load L moves along the fork 56A or 56B. In step 306, a change in angular position of the load detection arm is detected via the rotary sensor 130, whereby the rotary sensor generates corresponding rotational signals. In step 308, the position of the load L relative to a predefined location is determined from the rotational signals as the load L moves along the fork 56A, 56B.

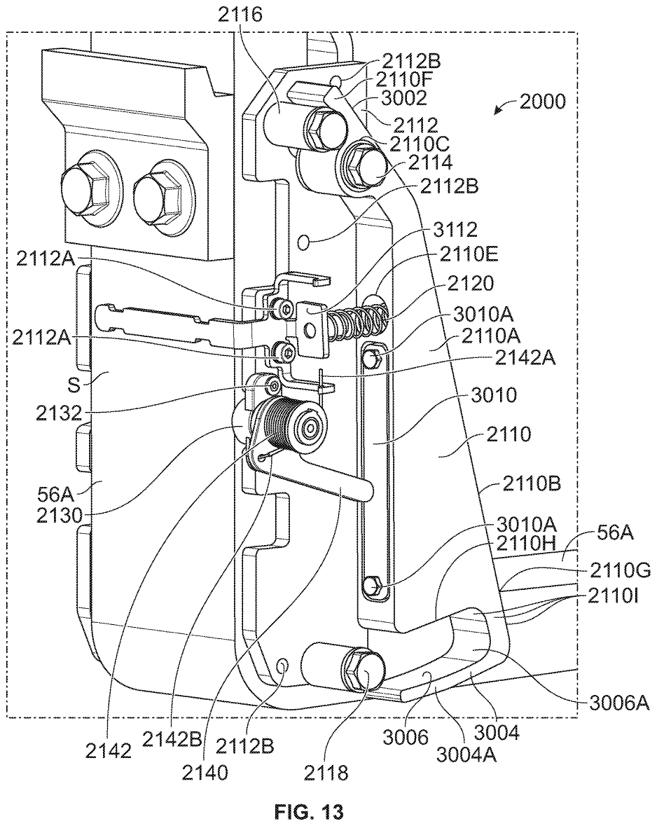

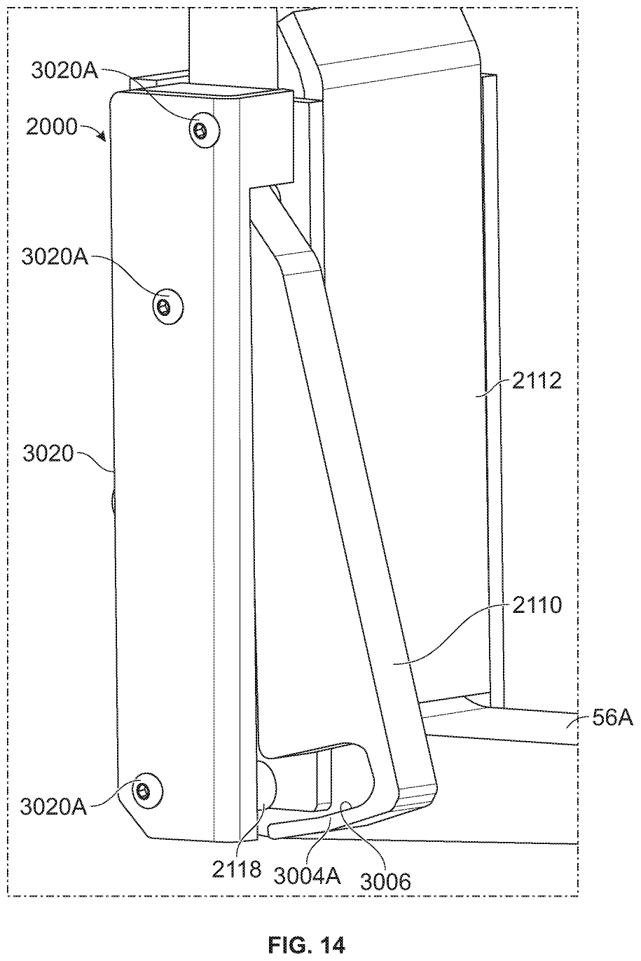

FIGS. 13 and 14 illustrate a further embodiment of a sensor device 2000, which may be used in place of one or both of the sensor devices 100, 101 in the FIG. 1 embodiment. The sensor device 2000 comprises a pivotable load detection arm 2110, which is coupled to the fork 56A. A mount 2112 may be welded, bolted or otherwise coupled to the fork 56A. In the illustrated embodiment, the mount 2112 is generally U-shaped so as to cover front and side portions of a lower part of a shank S of the fork 56A. The pivotable load detection arm 2110 may be pivotably or rotatably coupled to the mount 2112 via a shaft 2114 such that the detection arm 2110 rotates about the shaft 2114 relative to the fork 56A. Hence, the load detection arm 2110 is coupled to the fork 56A via the mount 2112 and the shaft 2114.

The load detection arm 2110 may comprise a main body 2110A having an outer front surface 2110B. The main body 2110A may comprise a bore 2110C for receiving the shaft 2114. The shaft 2114 may be coupled to the mount 2112 or directly to the fork 56A. A compression spring 2120 contacts and extends from a support bracket 3112 fixed to the mount 2112 via bolts 2112A or the like into a recess 2110E in the load detection arm 110 to engage and bias the load detection arm 110 in a direction toward the tip 156A, see FIG. 2, of the fork 56A or away from the heel H of the fork 56A. A torsional or any other spring could be used in place of the compression spring 2120. The main body 2110A further comprises upper and lower ends 3002 and 3004, wherein the upper end 3002 is located at an opposite end of the main body 2110A from the lower end 3004. The upper end 3002 comprises an upper stop 2110F, which engages with a first limit shaft 2116 fixed to the mount 2112 or the fork 56A. The first limit shaft 2116 is also referred to herein as an upper limit element. The upper stop 2110F engages with the limit shaft 2116 to stop or limit movement of the load detection arm 2110 toward the tip 156A of the fork 56A due to a force applied to the load detection arm 2110 by the spring 2120.

The lower end 3004 of the main body 2110A of the load detection arm 2110 comprises a leg 3004A that defines with adjacent portions 2110H and 2110I of the main body 2110A an open slot 3006 for limiting rotation of the load detection arm 2110 away from the tip 156A of the fork 56A. A second limit shaft 2118, also referred to herein as a lower limit element, is fixed to the mount 2112 or the fork 56A. Rotation of the load detection arm 2110 away from the tip 156A of the fork 56A stops when the portion 2110I of the main body 2110A of the load detection arm 2110 defining an end 3006A of the open slot 3006 engages the lower limit element 2118.

A rotary sensor 2130 may be coupled to the mount 2112 via one or more bolts 2132, see FIG. 13, so as to couple the sensor 2130 to the fork 56A. The rotary sensor 2130 may also be fastened directly to the fork 56A. A sensor arm 2140 may be coupled to the rotary sensor 2130 such that angular movement of the sensor arm 2140 is detected by the rotary sensor 2130. In the example of FIG. 13, the sensor arm 2140 engages with a cover 3010 coupled directly to the load detection arm 2110 via bolts 3010A. In the illustrated example, the load detection arm 2110 is hollow to reduce its weight and the cover 3010 covers an opening of the load detection arm 2110. Angular movement of the load detection arm 2110 causes corresponding angular movement of the sensor arm 2140. A torsion spring 2142 may be mounted to the mount 2112 or the rotary sensor 2130 having a leg 2142A which engages with the support bracket 3112 fixed to the mount 2112 and a further leg 2142B that engages with the sensor arm 2140. The spring 2142 biasing the sensor arm 2140 toward the load detection arm 2110 such that the sensor arm 2140 always contacts or engages the load detection arm 2110. Hence, the rotary sensor 2130 detects the angular position of the load detection arm 2110 via the sensor arm 2140 as angular movement of the load detection arm 2110 is transferred to the rotary sensor 2130 via the sensor arm 2140. The rotary sensor 2130 may comprise a rotary potentiometer, a rotary encoder hall-effect sensor, or any equivalent rotary or angle sensor.

The rotary sensor 2130 generates rotational signals, which are communicated to the control module 202 via the input/output module 204, see FIG. 3. The load detection arm 2110 pivots relative to the fork 56A in response to a load L making contact with and causing movement of the load detection arm 2110 against the bias of the spring 2120 as the load L moves along the fork 56A in a direction toward the heel H of the fork 56A. The rotary sensor 2130 detects a change in an angular position of the load detection arm 2110 and generates corresponding rotational signals which are indicative of the position of the load L relative to a predefined location as the load L moves along the fork 56A. As used herein, “a predefined location” is intended to be construed to cover the heel H or shank S of a fork 56A or 56B; a point 112A on the lower front surface of a mount 112, if a mount is provided; or any other location such as a point 441B on a member 440B of the fork carriage frame 44B, see FIGS. 2 and 4. Linear movement and position of the load L along the fork 56A after making contact with the load detection arm 2110 is capable of being determined by the control module 202 based on the rotational signals generated by the rotary sensor 2130.

A cover 3020 is mounted over a portion of the load detection arm 2110 and the rotary sensor 2130 and coupled to the mount 2112 via bolts 3020A that engage with threaded bores 2112B in the mount 2112, see FIGS. 13 and 14. The cover 3020 and the leg 3004A function to prevent debris, such as wood particles or dirt, from entering into the slot 3006, which debris may prevent full angular movement of the load detection arm 2110 in a direction away from the tip 156A of the fork 56A.

As noted above, the motion sensor 160A generates motion signals indicative of the speed and direction of rotation of the traction motor 160. The motion signals may be provided to the traction control module 212A, which determines the direction and speed of rotation of the traction motor 160 from those signals. The traction control module 212A then forwards the traction motor rotational speed and direction information to the control module 202 via the vehicle network system 210, whereby the control module 202 determines the speed of, direction of travel of and distance traveled by the power unit 12 from the traction motor rotational speed and direction information.

As also noted above, the traction control module 212A controls operation of the traction motor 160 and the hydraulic control module 212C controls operation of the one or more hydraulic motors 1212.

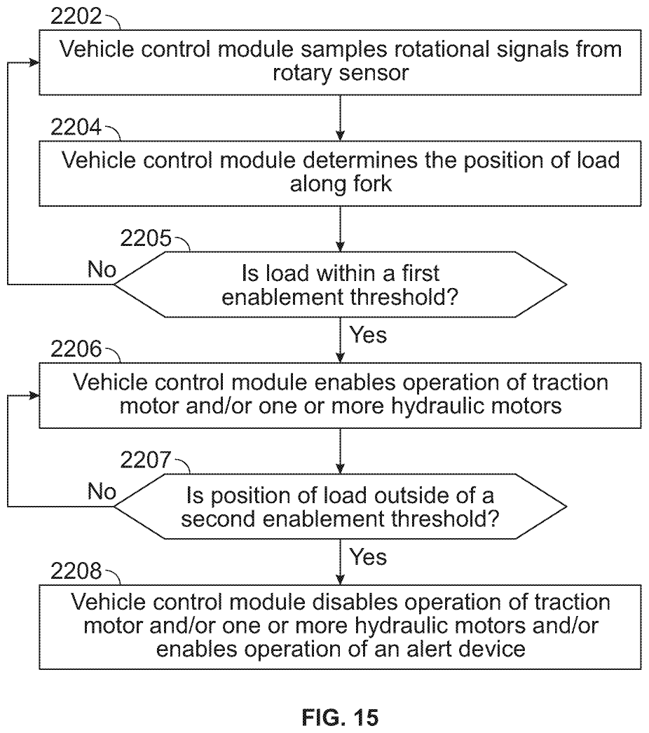

FIG. 15 is a flowchart of an example control algorithm or method for enabling and/or disabling operation of one or more vehicle functions based on the rotational signals from the rotary sensor 2130. The one or more vehicle functions may comprise operation of the traction motor 160; operation of the one or more hydraulic motors 1212; and/or operation of an alert device 212B as well as operation of any other devices on the vehicle.

In step 2202, the vehicle control module 202 receives and samples the rotational signals from the rotary sensor 2130.

In step 2204, the vehicle control module 202 determines from the rotational signals the position of a load L along the fork 56A when the load L is in contact with the load detection arm 110, 2110.

In step 2205, the vehicle control module 202 determines if the position of the load L is within a first enablement threshold ET₁ or first predetermined distance to a predefined location. If so, in step 2206, the vehicle control module 202 enables operation of the traction motor 160 via the traction control module 212A and/or the one or more hydraulic motors 1212 via the hydraulic control module 212C to effect lift of the fork 56A. If the position of the load L is not within the first enablement threshold ET₁ or first predetermined distance, the vehicle control module 202 returns to step 2202 and does not enable operation of the traction motor 160 or the one or more hydraulic motors 1212. Hence, in this embodiment, the vehicle control module 202 may enable operation of the traction motor 160 via the traction control module 212A and/or the one or more hydraulic motors 1212 via the hydraulic control module 212C to effect lift based on the position of the load L being within the first enablement threshold on one fork, such as fork 56A. In a further embodiment, the vehicle control module 202 may enable operation of the traction motor 160 via the traction control module 212A and/or the one or more hydraulic motors 1212 via the hydraulic control module 212C based on the position of the load L being within the first enablement threshold on both of the forks 56A, 56B.

The first enablement threshold ET₁ or first predetermined distance may be a small distance, such as 0.5 inch, 1.0 inch, or any other distance. As noted above, in FIG. 9, the load L has caused rotational movement of the load detection arm 110 to its fully inwardly rotated or fully engaged position, i.e., a minimum angular position M_{P}. In this state, the load Lis in engagement with a predefined location, e.g., a predefined location or front surface 112B of the mount 112 coupled to the fork 56A, such that the load L is unable to cause further inward movement or rotation of the load detection arm 110 toward the shank S of the fork 56A. Hence, in the FIG. 9 example, the load L is considered to be within the first enablement threshold ET₁ or first predetermined distance since the distance between the load L and the predefined location is zero. In the embodiment of FIGS. 13 and 14, the vehicle control module 202 would function in the same manner to enable operation of the traction motor 160 via the traction control module 212A and/or the one or more hydraulic motors 1212 via the hydraulic control module 212C to effect lift of the fork 56A when the load detection arm 2110 is fully rotated inwardly by a load L.

As noted above, the “predefined location” may comprise any other location such as a point 441B on a member 440B of the fork carriage frame 44B, see FIGS. 2 and 4. If the predefined location is a point 441B on the member 440B of the fork carriage frame 44B, the first predetermined distance may be slightly greater in this example than in the example wherein the predefined location is on the fork 56A or the mount 112, 2112 to account for the distance between the point 441B on the fork carriage frame 44B and a lower point 110G, 2110G on the outer front surface 110B, 2110B of the main body 110A, 2110A of the load detection arm 110, 2110. The lower point 110G, 2110G on the load detection arm 110, 2110 may be directly adjacent to a portion of the load L making contact with the load detection arm 110, 2110. Hence, the location or position of the lower point 110G, 2110G of the load detection arm 110, 2110 relative to the predefined location, i.e., the point 441B on the member 440B of the fork carriage frame 44B, is substantially equal to the location or position of the portion of the load L making contact with the load detection arm 110, 2110 relative to the predefined location.

As noted above, the control module 202 may be programmed to allow for continued operation of the traction motor 160 and/or the one or more hydraulic motors 1212 if the load L shifts slightly in a direction away from the heels H or shanks S of the forks 56A, 56B or the points 112A on the mounts 112 coupled to the forks 56A, 56B during operation of the vehicle. Hence, the control module 202 may be programmed with a second enablement threshold ET₂ or second predetermined distance, see FIG. 28, away from the predefined location such as the heels H or shanks S of the forks 56A, 56B or the points 112A on the mounts 112 coupled to the forks 56A, 56B.

In step 2207, the vehicle control module 202 determines if the position of the load L is greater than a second enablement threshold ET₂ or a second predetermined distance to the predefined location, see FIG. 28, wherein the second enablement threshold ET₂ is greater than the first enablement threshold. If so, in step 2208, the vehicle control module 202 disables operation of the traction motor 160 via the traction control module 212A and/or one or more of the hydraulic motors 1212 via the hydraulic control module 212C to effect lift of the fork 56A and/or enables operation of an alert device 212B, see FIG. 3. Hence, in this embodiment, the vehicle control module 202 disables operation of the traction motor 160 via the traction control module 212A and/or one or more of the hydraulic motors 1212 via the hydraulic control module 212C to effect lift of the fork 56A and/or enables operation of an alert device 212B, when the position of the load L is greater than a second enablement threshold ET₂ or a second predetermined distance to the predefined location on one of the forks 56A, 56B. In another embodiment, the vehicle control module 202 disables operation of the traction motor 160 via the traction control module 212A and/or one or more of the hydraulic motors 1212 via the hydraulic control module 212C to effect lift of the fork 56A and/or enables operation of an alert device 212B, when the position of the load L is greater than a second enablement threshold ET₂ or a second predetermined distance to the predefined location on both of the forks 56A, 56B.

The alert device 212B may comprise a vehicle display, which may generate a written and/or graphic alert to the operator that the load L is located beyond the second enablement threshold or second predetermined distance, a tone or sound generating device, which outputs an alert tone or sound or another known device for generating an alert signal to an operator. If the position of the load L is within the second enablement threshold ET₂ or second predetermined distance, the vehicle control module 202 returns to step 2206 and does not disable operation of the traction motor 160 or the one or more hydraulic motors 1212. The second enablement threshold or second predetermined distance may be greater than the first enablement threshold or first predetermined distance and the second enablement threshold may comprise 1.5 inches, 2.0 inches, or any other distance. An example second enablement threshold ET₂ or second predetermined distance is illustrated in FIGS. 8 and 28. As noted above, FIG. 8 illustrates the load L after it has engaged and caused some rotational movement of the load detection arm 110 in a clockwise direction as viewed in the FIG. 8. In this state, the load L is located outside or beyond the second enablement threshold ET₂ or second predetermined distance. If the load L was within the first enablement threshold ET₁ or first predetermined distance but then moved outside of the second enablement threshold ET₂ or second predetermined distance, the control module 202 would disable operation of the traction motor 160 via the traction control module 212A and/or one or more of the hydraulic motors 1212 via the hydraulic control module 212C to effect lift of the fork 56A and/or enable operation of an alert device 212B. If the load L had not yet crossed the first enablement threshold ET₁ or first predetermined distance while on the fork 56A, the control module 202 would not enable operation of the traction motor 160 via the traction control module 212A and/or one or more of the hydraulic motors 1212 via the hydraulic control module 212C to effect lift of the fork 56A and/or enable operation of an alert device 212B. In the embodiment of FIGS. 13 and 14, the vehicle control module 202 would function in the same manner when the load detection arm 2110 and the load L are located beyond the second enablement threshold ET₂ or second predetermined distance.

It is also contemplated that the vehicle control module 202 may disable operation of only one of the traction motor 160 or the one or more of the hydraulic motors 1212 when the position of the load L is greater than the second enablement threshold ET₂ and disable operation of the other one of the traction motor 160 or the one or more of the hydraulic motors 1212 when the position of the load L is greater than a third enablement threshold ET₃, which third enablement threshold ET₃ is greater than the second enablement threshold ET₂, see FIG. 28.

Hence, the vehicle control module 202 enables and/or disables operation of one or more vehicle functions based on the rotational signals from the rotary sensor 130, 2130. “Disable” as used herein is intended to cover disabling or not enabling operation of one or more vehicle functions.

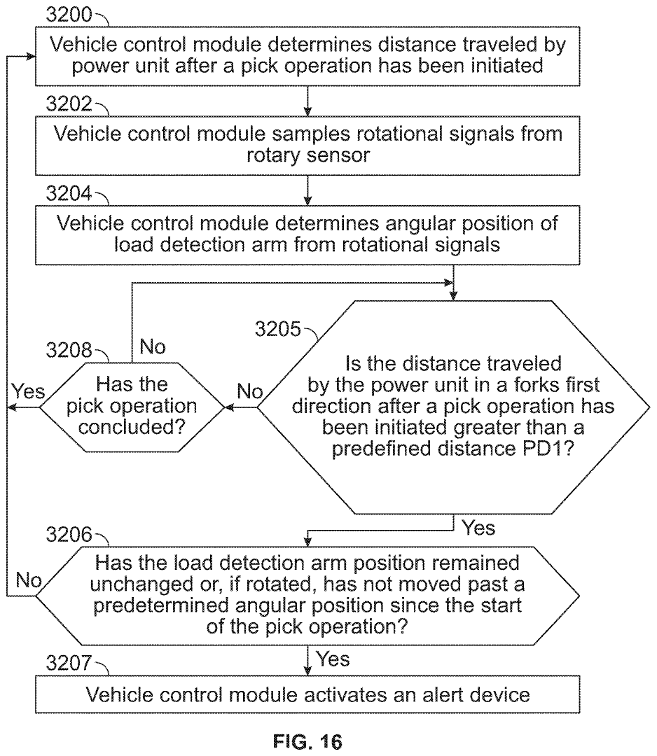

FIG. 16 is a flowchart of an example control algorithm or method for activating an alert device 212B when, after a pick operation has been initiated, a distance traveled by the power unit 12 in a forks first direction is greater than a predefined distance and the position of the load detection arm 110, 2110, as determined by the rotational signals from the rotary sensor 130, 2130, has not moved past a predetermined angular position A_{PD} from the home position Hp since the initiation of the pick operation. Hence, the vehicle control module 202 activates an alert device based on the motion signals from the motion sensor 160A and the rotational signals from the rotary sensor 130, 2130. A “pick operation” involves the vehicle 10 moving toward a load L, such as a pallet P, so the forks 56A, 56B engage the pallet P to effect movement of the pallet P.

In step 3200, the vehicle control module 202 receives the traction motor rotational speed and direction information from the traction control module 212A, which information is based on the motion signals from the motion sensor 160A. From the traction motor rotational speed and direction information, the vehicle control module 202 determines the distance traveled by the power unit 12 once a pick operation has been initiated by an operator, i.e., the distance traveled by the power unit 12 during the pick operation is determined by the control module 202. The vehicle control module 202 may determine when to start measuring the distance traveled by the power unit 12 at the start of a given pick operation as follows. If the vehicle is operating as an autonomous vehicle and is receiving pick commands/instructions from an inventory management system (IMS), such as a warehouse management system (WMS); a warehouse execution system (WES); or similar system, (not shown), which IMS communicates with the vehicle 10, the IMS may provide a command to the vehicle 10 to pick a load at a specific station in a warehouse, which station has a predefined location in X, Y and Z directions in the warehouse, which predefined location is provided to the vehicle from the IMS or is pre-stored in memory on the vehicle. The vehicle control module 202 may start measuring the distance it travels for a given pick operation once the vehicle 10 is located at a predefined start location in front of the load L, which predefined start location may be received from the IMS or pre-stored in memory. The location of vehicle 10 relative to the predefined start location in front of the load L is known by the vehicle 10, such as by the vehicle using an environmental based location tracking system (not shown) or other known location detection technology provided on the vehicle 10. It is also contemplated that a sensor may monitor a specific load location, e.g., a sensor may monitor an end of a conveyor where a load may be positioned, and generate a signal to the vehicle 10 to initiate a pick operation once a load is sensed. When the load has moved from the specific load location, as sensed by the sensor, the vehicle control module 202 may begin measuring the distance the power unit 12 moves during the pick operation. It is further contemplated that a sensor may be positioned at or near a pick location to monitor and detect the vehicle 10 when near the pick location such that when the sensor senses the vehicle 10, it generates a signal to the vehicle control module 202 causing the vehicle control module 202 to begin measuring the distance the power unit 12 moves during the pick operation. If the vehicle 10 is being manually operated, an operator may activate a switch or enter a start command on a user interface screen that the pick operation is being initiated/started thereby indicating to the vehicle control module 202 that the module 202 should begin measuring the distance the power unit 12 moves during a current pick operation.

In step 3202, the vehicle control module 202 receives and samples the rotational signals from the rotary sensor 130, 2130.

In step 3204, the vehicle control module 202 determines from the rotational signals the angular position of load detection arm 110, 2110.

In step 3205, the vehicle control module 202 determines if the distance traveled by the power unit 12 in a forks first direction after a pick operation has been initiated is greater than a predefined distance PD₁. If the distance traveled is greater than the predefined distance PD₁, in step 3206, the vehicle control module 202 determines if the position of the load detection arm 110, 2110, as determined by the rotational signals, has not changed or, if the arm 110, 2110 has rotated, the arm 110, 2110 has not rotated past a predetermined angular position A_{PD} from the home position H_{P} since the initiation of the pick operation. In FIG. 7, an example predetermined angular position A_{PD} for the load detection arm 110, 2110 is illustrated in phantom, where the arm 110, 2110 has moved clockwise through an angle A₁₁₀ from its home H_{P} to the predetermined angular position A_{PD}. The predetermined angular position A_{PD} for the load detection arm 110, 2110 can be defined by a technician as any angular position between the home position H_{P}, see FIG. 7, and the minimum angular position M_{P}, see FIG. 9, for the load detection arm 110, 2110. It is contemplated that the predetermined angular position A_{PD} may be defined such that when the load detection arm is at the predetermined angular position A_{PD}, the load is at or near the first enablement threshold ET₁. If the position of the load detection arm 110, 2110 has not changed or, if rotated, has not rotated past the predetermined angular position A_{PD}, in step 3207, the vehicle control module 202 activates the alert device 212B. If the position of the load detection arm 110, 2110 has moved past the predetermined angular position A_{PD}, the vehicle control module 202 returns to step 3200 and waits to receive a new pick command. If the distance traveled by the power unit 12 in the forks first direction after a pick operation has been initiated is not greater than the predefined distance PD₁, the vehicle control module 202 determines if the pick operation is still ongoing, i.e., has not concluded, see step 3208. If the pick operation is still ongoing, the vehicle control module 202 will return to step 3205. If the pick operation has been concluded, the vehicle control module 202 will return to step 3200 and wait for a new pick operation to be initiated. The vehicle control module 202 will know when a pick operation has been concluded, such as when the vehicle 10 receives a command from the IMS or the operator to terminate the pick operation, the vehicle 10 receives a new pick request or a weight sensor (not shown) on the vehicle 10 senses a weight on the forks 56A and 56B that is of a sufficiently high value to indicate that a load has been engaged and lifted by the forks 56A and 56B.

The steps in FIG. 16 involve one load detection arm 110 of one sensor device 100, 101, 1000. It is contemplated that the steps in FIG. 16 could apply to a first load detection arm 110, 2110 of a first sensor device 100 on one fork 56A and also to a second load detection arm 110, 2110 of a second sensor device 101 on a second fork 56B. Hence, in a first embodiment, the alert device 212B could be activated if the position of a load detection arm of only one sensor device on one fork has not changed or, if rotated, has not rotated past the predetermined angular position A_{PD}. It is also contemplated that, in a second embodiment, the alert device 212B could be activated only if the position of load detection arms of first and second sensor devices on the first and second forks 56A and 56B have not changed or, if rotated, have not rotated past the predetermined angular position A_{PD}.

The predefined distance PD₁ may be downloaded to the vehicle control module 202 by the IMS, pre-stored in memory associated with the vehicle control module 202 or measured by a distance sensor on the vehicle, such as by a known Lidar sensor. For example, when an operator activates a switch or enters a start command on a user interface screen to initiate a new pick operation, the vehicle control module 202 may cause the Lidar sensor to provide the vehicle control module 202 with a distance signal corresponding to the distance from the vehicle to the load L, which distance signal would define the predefined distance PD₁. The IMS may also command the vehicle control module 202 to access a distance signal from the Lidar sensor, once the vehicle is near the pick location, e.g., at a predefined start location in front of the load, which distance signal would define the predefined distance PD₁.

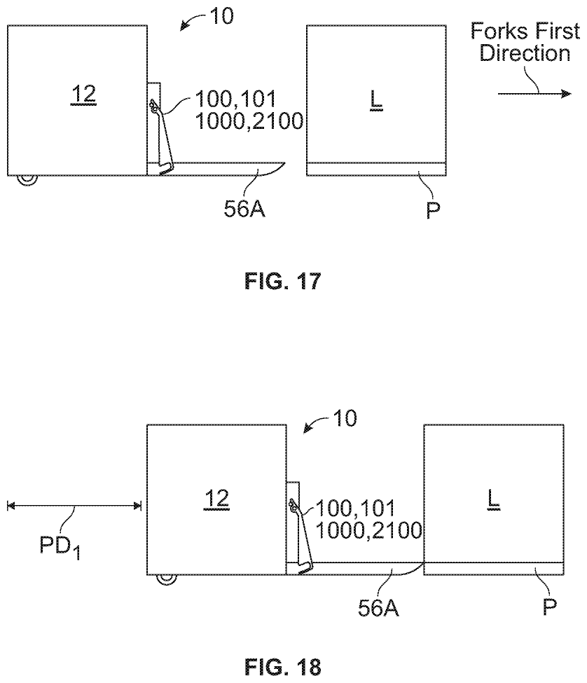

FIG. 17 illustrates a power unit 12 at an initial position prior to a pick operation being initiated. FIG. 18 illustrates the power unit 12 moving, after a pick operation has been initiated, a distance greater than a predefined distance PD₁ and the position of the load detection arm 110, 2110 has not changed during the pick operation. Hence, in the example of FIGS. 17 and 18, the vehicle control module 202 activates the alert device 212B to indicate that the load L has not been fully loaded on the forks 56A, 56B. This may occur, for example, when the forks 56A, 56B engage and push the load L forward without fully entering openings in the pallet P such that the load L moves with the forks 56A, 56B instead of the forks 56A, 56B moving within openings in the pallet P as the pallet P remains stationary.

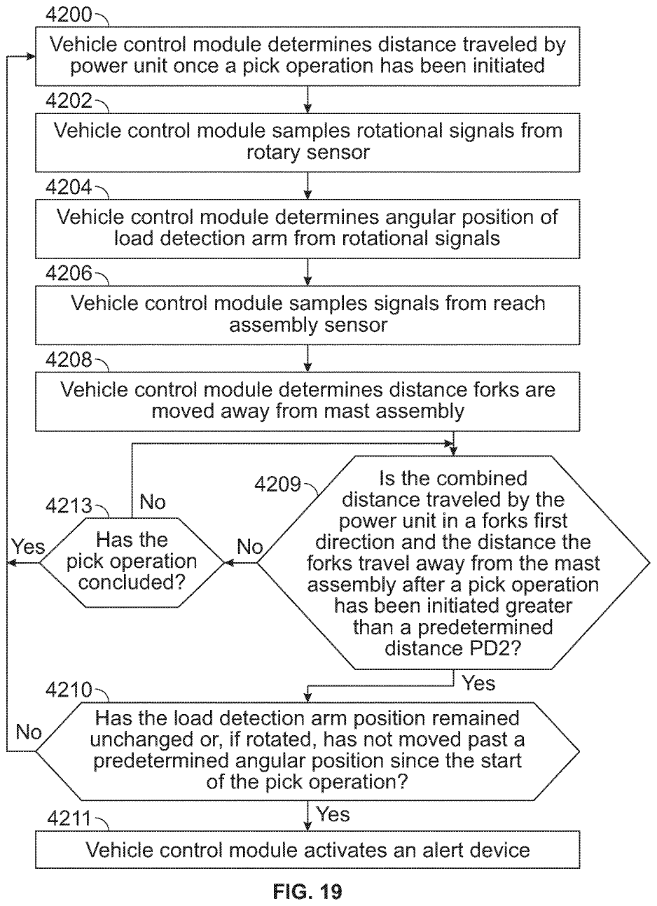

FIG. 19 is a flowchart of an example control algorithm or method for activating an alert device 212B when, after a pick operation has been initiated, a combined distance traveled by the power unit 12 in a forks first direction and the distance the forks 56A and 56B travel in a direction away from the mast assembly 42 is greater than a predefined distance PD₂ and the position of the load detection arm 110, 2110, as determined by the rotational signals, has not moved past a predetermined angular position A_{PD} from the home position Hp since the initiation of the pick operation.

In step 4200, the vehicle control module 202 receives the traction motor rotational speed and direction information from the traction control module 212A, which information is based on the motion signals from the motion sensor 160A. From the traction motor rotational speed and direction information, the vehicle control module 202 determines the distance traveled by the power unit 12 once a pick operation has been initiated by an operator, i.e., the vehicle control module 202 starts measuring the distance traveled by the power unit 12 after the pick operation has been initiated.

In step 4202, the vehicle control module 202 receives and samples the rotational signals from the rotary sensor 130, 2130.

In step 4204, the vehicle control module 202 determines from the rotational signals the angular position of load detection arm 110, 2110.

In step 4206, the vehicle control module 202 receives and samples the signals from the reach assembly sensor 208A.

In step 4208, the vehicle control module 202 determines from the signals from the reach assembly sensor 208A the distance the forks 56A and 56B are located away from the mast assembly 42.

In step 4209, the vehicle control module 202 determines, after a pick operation has been initiated, if a combined distance traveled by the power unit 12 in a forks first direction and the distance the forks 56A and 56B travel away from the mast assembly 42 is greater than a predefined distance PD₂. If the combined distance is greater than the predefined distance PD₂, in step 4210, the vehicle control module 202 determines if the position of the load detection arm 110, 2110, as determined by the rotational signals, has not changed, or, if the arm 110, 2110 has rotated, the arm 110, 2110 has not rotated past a predetermined angular position A_{PD} from the home position H_{P} since the initiation of the pick operation. The predetermined angular position A_{PD} for the load detection arm 110, 2110 can be defined by a technician as any position between the home position H_{P}, see FIG. 7, and the minimum angular position M_{P}, see FIG. 9, for the load detection arm 110, 2110. If the position of the load detection arm has not changed or, if rotated, has not rotated past the predetermined angular position A_{PD}, in step 4211, the vehicle control module 202 activates the alert device 212B. If the position of the load detection arm 110, 2110 has moved past the predetermined angular position A_{PD}, the vehicle control module 202 returns to step 4200 and the vehicle control module waits for a new pick operation to begin. If, in step 4209, the distance traveled by the power unit 12 in the forks first direction after a pick operation has been initiated is not greater than the predefined distance PD₂, the vehicle control module 202 determines if the pick operation is still ongoing, i.e., has not concluded, see step 4213. If the pick operation is still ongoing, the vehicle control module 202 will return to step 4209. If the pick operation has been concluded, the vehicle control module 202 will return to step 4200 and wait for a new pick operation to be initiated.

The steps in FIG. 19 involve one load detection arm 110 of one sensor device 100, 101, 1000. It is contemplated that the steps in FIG. 19 could apply to a first load detection arm 110, 2110 of a first sensor device 100 on one fork 56A and also to a second load detection arm 110, 2110 of a second sensor device 101 on a second fork 56B. Hence, in one embodiment, the alert device 212B could be activated if the position of a load detection arm of only one sensor device on one fork has not changed or, if rotated, has not rotated past the predetermined angular position A_{PD}. It is also contemplated that, in another embodiment, the alert device 212B could be activated only if the position of load detection arms of first and second sensor devices on the first and second forks 56A and 56B have not changed or, if rotated, have not rotated past the predetermined angular position A_{PD}.

The predefined distance PD₂ may be downloaded to the vehicle control module 202 by the IMS, pre-stored in memory associated with the vehicle control module 202 or measured by a distance sensor on the vehicle, such as by a known Lidar sensor. For example, when an operator activates a switch or enters a start command on a user interface screen to initiate a new pick operation, the vehicle control module 202 may cause the Lidar sensor to provide the vehicle control module 202 with a distance signal corresponding to the distance from the vehicle to the load L, which distance signal would define the predefined distance PD₂. The IMS may also command the vehicle control module 202 to access a distance signal from the Lidar sensor, once the vehicle is near the pick location, e.g., at a predefined start location in front of the load, which distance signal would define the predefined distance PD₂.

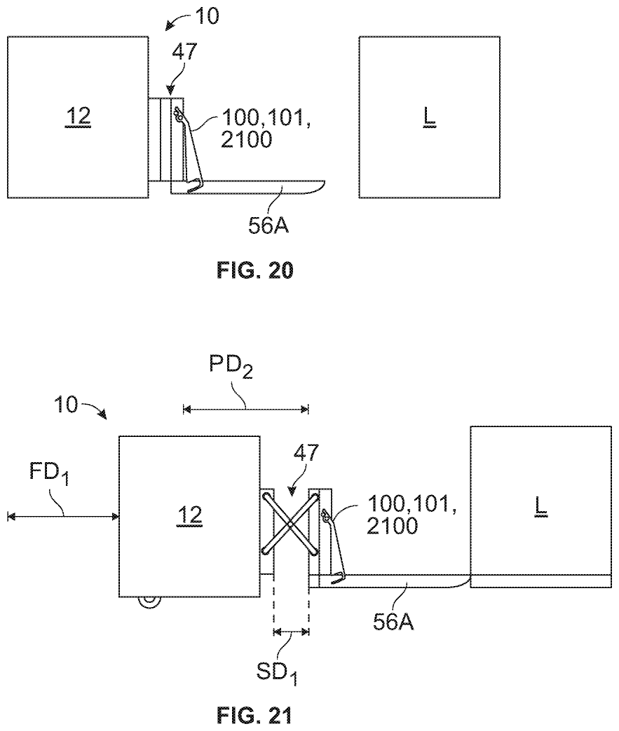

FIG. 20 illustrates a power unit 12 at an initial position prior to a pick operation being initiated and the forks 56A and 56B positioned adjacent to the mast assembly 42 via the reach mechanism 47. FIG. 21 illustrates the power unit 12 moving, after a pick operation has been initiated, a first distance FD₁ and the forks 56A and 56B being extended away from the mast assembly 42 via the reach mechanism 47 by a second distance SD₁ such that the summation of the first and second distances FD₁ and SD₁ is greater than a predefined distance PD₂ and the position of the load detection arm 110, 2110, as determined by the rotational signals, has not changed. Hence, in the example of FIGS. 20 and 21, the vehicle control module 202 activates the alert device 212B to indicate to the operator or IMS that the load has not been properly engaged. This may occur, for example, when the forks 56A, 56B engage and push the load L forward without fully entering openings in the pallet P such that the load L moves with the forks 56A, 56B instead of the forks 56A, 56B moving within openings in the pallet P as the pallet P remains generally stationary.

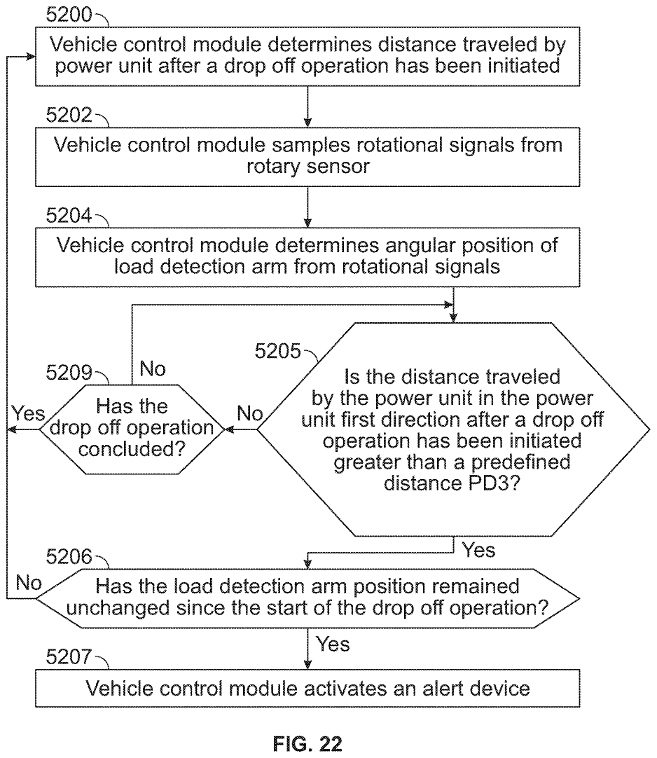

FIG. 22 is a flowchart of an example control algorithm or method for activating an alert device 212B when, during an operation to drop off a load L from the fork(s) 56A, 56B, a distance traveled by the power unit 12 in a power unit first direction is greater than a predefined distance PD₃ and the position of the load detection arm 110, 2110, as determined by the rotational signals, has not changed.

In step 5200, the vehicle control module 202 receives the traction motor rotational speed and direction information from the traction control module 212A, which information is based on the motion signals from the motion sensor 160A. From the traction motor rotational speed and direction information, the vehicle control module 202 determines the distance traveled by the power unit 12 once a drop off operation has been initiated by an operator, i.e., the distance traveled by the power unit 12 during the drop off operation is determined by the control module 202. A “drop off operation” involves, for example, the forks 56A and 56B moving to a position where the load L is placed on a floor, ground or the like and the vehicle 10 moves in a power unit first direction to remove the forks 56A and 56B from engagement with the load L.

The vehicle control module 202 may determine when to start measuring the distance traveled by the power unit 12 at the start of a given drop off operation as follows. If the vehicle is operating as an autonomous vehicle and is receiving drop off commands/instructions from a inventory management system IMS, such as a WMS; a WES; or similar system (not shown), which IMS communicates with the vehicle 10, the IMS may provide a command to the vehicle 10 to drop off a load at a specific station in a warehouse, which station has a predefined location in X, Y and Z directions in the warehouse, which predefined location is provided to the vehicle from the IMS or is pre-stored in memory on the vehicle. The vehicle control module 202 may start measuring the distance it travels for a given drop off operation once the vehicle 10 is located at a predefined start location in front of the station where the load is to be placed. The location of vehicle 10 relative to the predefined start location in front of the load L is known by the vehicle 10, such as by an environmental based location tracking system (not shown) or other known location detection technology provided on the vehicle 10. It is further contemplated that a sensor may be positioned at or near a drop off location to monitor and detect the vehicle 10 when near the drop off location such that when the sensor senses the vehicle 10, it generates a signal to the vehicle control module 202 causing the vehicle control module 202 to begin measuring the distance the power unit 12 moves during the drop off operation. If the vehicle 10 is being manually operated, an operator may activate a switch or enter a start command on a user interface screen thereby indicating to the vehicle control module 202 that the module 202 should begin measuring the distance the power unit 12 moves during a current drop off operation.

In step 5202, the vehicle control module 202 receives and samples the rotational signals from the rotary sensor 2130.

In step 5204, the vehicle control module 202 determines from the rotational signals the angular position of the load detection arm 110, 2110.

In step 5205, the vehicle control module 202 determines if the distance traveled by the power unit 12 in a power unit first direction after a drop off operation has been initiated is greater than a predefined distance PD₃. If the distance traveled is greater than the predefined distance PD₃, the vehicle control module 202 determines if the position of the load detection arm 110, 2110, as determined by the rotational signals, has not changed, see step 5206. The position of the load detection arm 110, 2110 is presumed to be either at its fully inwardly rotated or fully engaged position, i.e., a minimum angular position, or a position where the load L is located within a first enablement threshold ET₁ or first predetermined distance to a predefined location such as the heel H or shank S of the fork 56A or the point 112A on the mount 112. If the position of the load detection arm 110, 2110 has not changed, in step 5207, the vehicle control module 202 activates the alert device 212B since the distance traveled by the power unit 12 in a power unit first direction after the drop off operation was initiated was greater than the predefined distance PD₃ and the position of the load detection arm 110, 2110, as determined by the rotational signals, did not changed.

If the position of the load detection arm 110, 2110 has changed in step 5206, the vehicle control module 202 returns to step 5200 and the vehicle control module 202 waits for a new drop off operation to begin. If, in step 5205, the distance traveled by the power unit 12 in the forks first direction after a drop off operation has been initiated is not greater than the predefined distance PD₃, the vehicle control module 202 determines if the drop off operation is still ongoing, i.e., has not concluded, see step 5209. If the drop off operation is still ongoing, the vehicle control module 202 will return to step 5205. If the drop off operation has been concluded, the vehicle control module 202 will return to step 5200 and wait for a new drop off operation to be initiated. The vehicle control module 202 will know when a drop off operation has been concluded, such as when the vehicle 10 receives a command from the IMS or the operator to terminate the drop off operation, or a weight sensor (not shown) on the vehicle 10 senses a weight reduction on the forks 56A and 56B to indicate that the load is no longer positioned on the forks 56A and 56B.

The steps in FIG. 22 involve one load detection arm 110 of one sensor device 100, 101, 1000. It is contemplated that the steps in FIG. 22 could apply to a first load detection arm 110, 2110 of a first sensor device 100 on one fork 56A and also to a second load detection arm 110, 2110 of a second sensor device 101 on a second fork 56B. Hence, in a first embodiment, the alert device 212B could be activated if the position of a load detection arm of only one sensor device on one fork has not changed. It is also contemplated that, in a second embodiment, the alert device 212B could be activated only if the position of load detection arms of first and second sensor devices on the first and second forks 56A and 56B have not changed.

The predefined distance PD₃ may be downloaded to the vehicle control module 202 by the IMS, pre-stored in memory associated with the vehicle control module 202 or measured by a distance sensor on the vehicle, such by a known Lidar sensor. For example, when an operator activates a switch or enters a start command on a user interface screen to initiate a new drop off operation, the vehicle control module 202 may sample the Lidar sensor to receive a distance signal corresponding to the distance from the vehicle to the drop off location, which distance signal would define the predefined distance PD₃. The IMS may also command the vehicle control module 202 to access a distance signal from the Lidar sensor, once the vehicle is near the drop off location, e.g., at a predefined start location in front of the station where the load is to be placed, which distance signal would define the predefined distance PD₃.

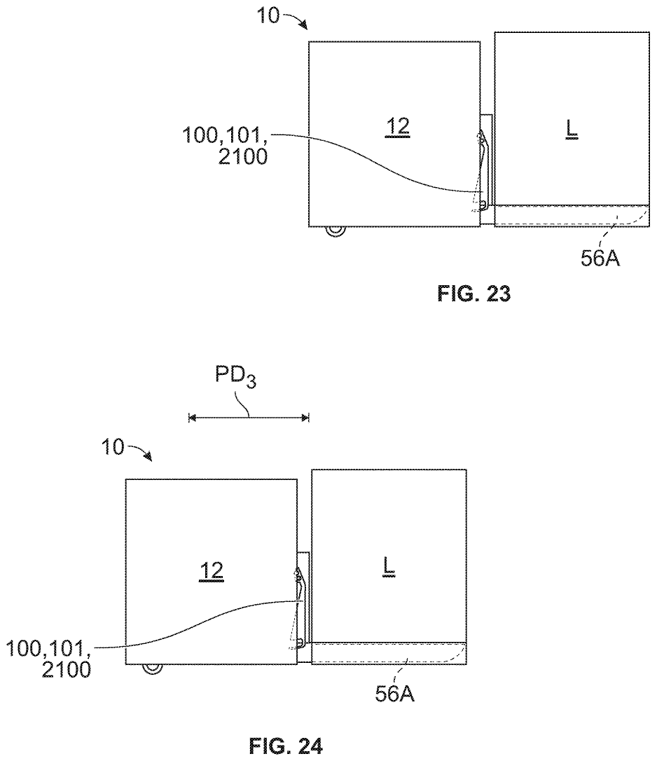

FIG. 23 illustrates a power unit 12 at an initial position prior to a drop off operation being initiated. FIG. 24 illustrates the power unit 12 moving, after a drop off operation has been initiated, a distance greater than a predefined distance PD₃ and the position of the load detection arm 110, 2110 has not changed. Hence, in the example of FIGS. 23 and 24, the vehicle control module 202 activates the alert device 212B to indicate to the operator that load L has not been disengaged from the forks 56A and 56B.

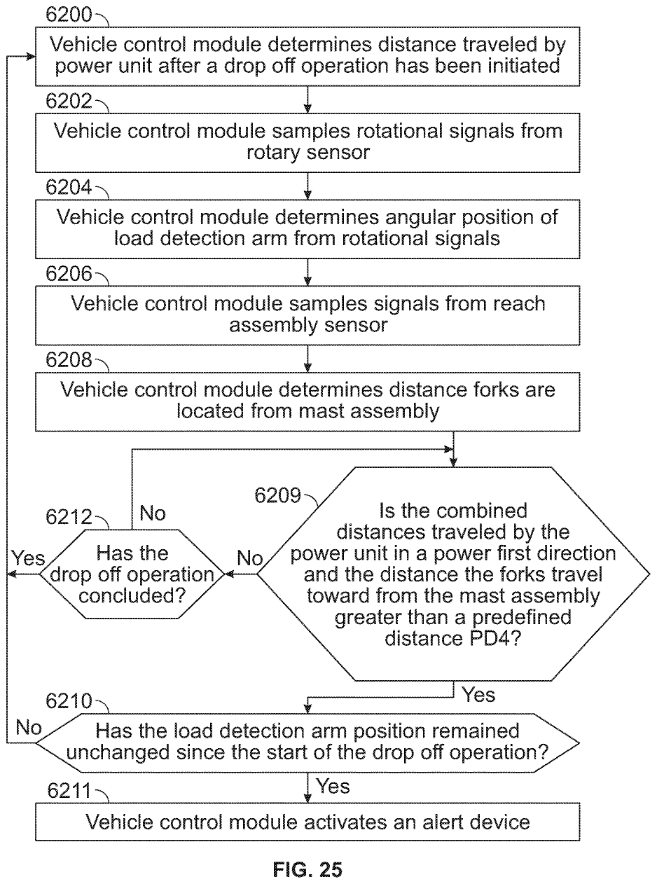

FIG. 25 is a flowchart of an example control algorithm or method for activating an alert device 212B when, after a drop off operation has been initiated, a combined distance traveled by the power unit 12 in a power unit first direction and the distance the forks 56A and 56B travel in a direction toward the mast assembly 42 is greater than a predefined distance PD₄ and the position of the load detection arm 110, 2110, as determined by the rotational signals, has not changed.

In step 6200, the vehicle control module 202 receives the traction motor rotational speed and direction information from the traction control module 212A, which information is based on the motion signals from the motion sensor 160A. From the traction motor rotational speed and direction information, the vehicle control module 202 determines the distance traveled by the power unit 12 once a drop off operation has been initiated by an operator, i.e., the vehicle control module 202 starts measuring the distance traveled by the power unit 12 after the drop off operation has been initiated.

In step 6202, the vehicle control module 202 receives and samples the rotational signals from the rotary sensor 2130.

In step 6204, the vehicle control module 202 determines from the rotational signals the angular position of the load detection arm 110, 2110.

In step 6206, the vehicle control module 202 receives and samples the signals from the reach assembly sensor 208A.

In step 6208, the vehicle control module 202 determines from the signals from the reach assembly sensor 208A the distance the forks 56A and 56B move toward the mast assembly 42 after the drop off operation has been initiated.

In step 6209, the vehicle control module 202 determines if a combined distance traveled by the power unit 12 in a power unit first direction and the distance the forks 56A and 56B travel toward the mast assembly 42 is greater than a predefined distance PD₄. If the combined distance is greater than the predefined distance PD₄, the vehicle control module determines if the position of the load detection arm 110, 2110, as determined by the rotational signals, has not changed. If the position of the load detection arm 110, 2110 has not changed, then vehicle control module 202 activates the alert device 212B, in step 6211, since, after the drop off operation was initiated, the combined distance traveled by the power unit 12 in the power unit first direction and the distance the forks 56A and 56B travel toward the mast assembly 42 was greater than the predefined distance PD₄ and the position of the load detection arm 110, 2110, as determined by the rotational signals, was not changed. If the position of the load detection arm 110, 2110 has changed, the vehicle control module 202 returns to step 6200 and the vehicle control module waits for a new drop off operation to begin. If, in step 6209, the combined distance traveled by the power unit 12 in the power unit first direction and the distance the forks 56A and 56B travel toward the mast assembly 42 after a drop off operation has been initiated is not greater than the predefined distance PD₄, the vehicle control module 202 determines if the drop off operation is still ongoing, i.e., has not concluded, see step 6212. If the drop off operation is still ongoing, the vehicle control module 202 will return to step 6209. If the drop off operation has been concluded, the vehicle control module 202 will return to step 6200 and wait for a new drop off operation to be initiated.

The steps in FIG. 25 involve one load detection arm 110 of one sensor device 100, 101, 1000. It is contemplated that the steps in FIG. 22 could apply to a first load detection arm 110, 2110 of a first sensor device 100 on one fork 56A and also to a second load detection arm 110, 2110 of a second sensor device 101 on a second fork 56B. Hence, in one embodiment, the alert device 212B could be activated if the position of a load detection arm of only one sensor device on one fork has not changed. It is also contemplated that, in another embodiment, the alert device 212B could be activated only if the position of load detection arms of first and second sensor devices on the first and second forks 56A and 56B have not changed.

The predefined distance PD₄ may be downloaded to the vehicle control module 202 by the IMS, pre-stored in memory associated with the vehicle control module 202 or measured by a distance sensor on the vehicle, such by a known Lidar sensor. For example, when an operator activates a switch or enters a start command on a user interface screen to initiate a new drop off operation, the vehicle control module 202 may cause the Lidar sensor to provide the vehicle control module 202 with a distance signal, which distance signal would define the predefined distance PD₄. The IMS may also command the vehicle control module 202 to access a distance signal from the Lidar sensor, which distance signal would define the predefined distance PD₄.

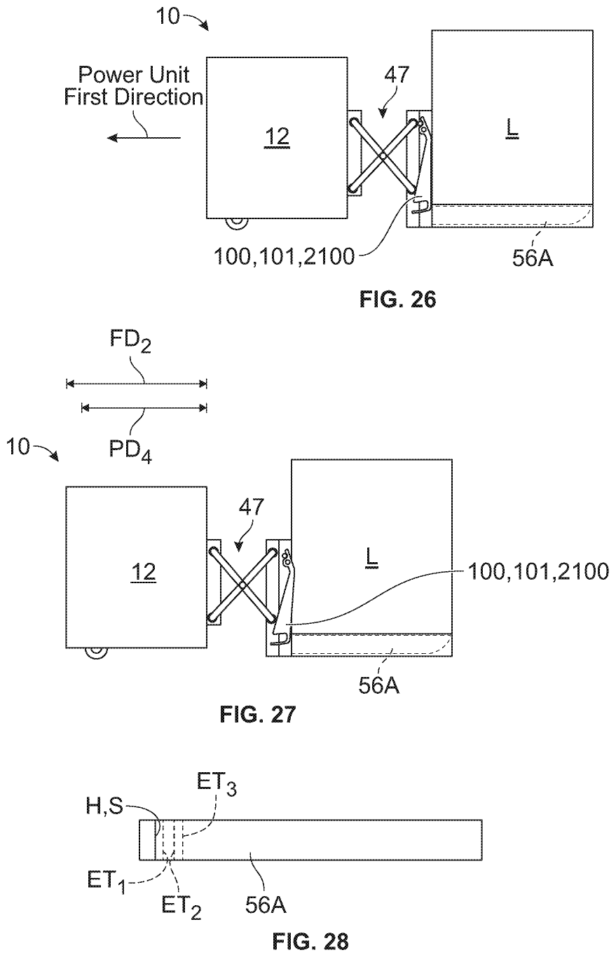

FIG. 26 illustrates a power unit 12 at an initial position prior to a drop off operation being initiated with the forks 56A and 56B extending away from the mast assembly 42. In the FIG. 27 example, the power unit 12 has moved a first distance FD₂ greater than the predefined distance PD₄ after the drop off operation was initiated. The forks 56A and 56B remained at the same position as in FIG. 26 during the drop off operation. Hence, the forks 56A and 56B move towards the mast assembly by a second distance equal to zero. The summation of the first and second distances is greater than the predefined distance PD₄ and the position of the load detection arm 110, 2110, as determined by the rotational signals, has not changed. Hence, in the example of FIGS. 26 and 27, the vehicle control module 202 activates the alert device 212B to indicate to the operator that load L has not been disengaged from the forks 56A and 56B.

As used herein, “one or more memory devices for collectively storing executable instructions; one or more microprocessors in communication with the one or more memory devices, wherein the one or more microprocessors are collectively configured when executing the executable instructions to” means one microprocessor may perform the defined functions or a plurality of microprocessors may collectively perform the defined functions such that the execution of the individual defined functions may be divided amongst such microprocessors.

Having thus described the above aspects of the disclosure in detail and by reference to embodiments thereof, it will be apparent that modifications and variations are possible without departing from the scope of the disclosure defined in the appended claims.

What is claimed is:

1. A sensor device on a fork of a materials handling vehicle, the sensor device comprising:
a pivotable load detection arm coupled to the fork, the load detection arm comprising a main body comprising a lower end near a heel of the fork and an upper end at an opposite end of the main body from the lower end, the upper end of the main body of the load detection arm comprises an upper stop for limiting rotation of the load detection arm toward a tip of the fork and the lower end of the main body of the load detection arm comprises a slot for limiting rotation of the load detection arm away from the tip of the fork;
a rotary sensor coupled to the fork and associated with the load detection arm, the rotary sensor generating rotational signals as the load detection arm pivots relative to the fork in response to a load making contact with and causing movement of the load detection arm as the load moves along the fork, wherein linear movement of the load along the fork after making contact with the load detection arm is capable of being determined based on the rotational signals generated by the rotary sensor.

2. The sensor device of claim 1, wherein the load detection arm is directly coupled to the rotary sensor.

3. The sensor device of claim 1, further comprising a sensor arm coupled to the rotary sensor, the sensor arm in engagement with the load detection arm for angular movement with the load detection arm.

4. The sensor device of claim 1, further comprising:
a mount coupled to the fork, the pivotable load detection arm and the rotary sensor are coupled to an outer side portion of the fork via the mount; and
an upper limit element coupled to the mount, the upper stop on the main body of the load detection arm engages the upper limit element to limit rotation of the load detection arm toward the tip of the fork.

5. The sensor device of claim 4, further comprising a lower limit element coupled to the mount, wherein the slot on the main body of the load detection arm comprises an open slot and rotation of the load detection arm away from the tip of the fork stops when a portion of the main body of the load detection arm defining an end of the open slot engages the lower limit element.

6. The sensor device of claim 1, further comprising:
a mount coupled to the fork, the pivotable load detection arm and the rotary sensor are coupled to the fork via the mount; and
a cover coupled to the mount to enclose the load detection arm and the rotary sensor.

7. The sensor device of claim 1, wherein the main body of the load detection arm is hollow and further comprising:
a spring for biasing the load detection arm outward; and
as the load is received and moves along the fork in a direction toward the heel of the fork, the load engages with the load detection arm causing the load detection arm to move against the bias of the spring in a direction toward the heel of the fork, the rotary sensor detects a change in angular position of the load detection arm and generates corresponding rotational signals which are indicative of the position of the load relative to a predefined location as the load moves along the fork.

8. The sensor device of claim 1, wherein the rotary sensor comprises one of a rotary potentiometer or a rotary encoder hall-effect sensor.

9. A method for detecting a position of a load on a fork of a materials handling vehicle comprising:
providing a sensor device comprising:
a pivotable load detection arm coupled to the fork, the load detection arm comprising a main body comprising a lower end near a heel of the fork and an upper end at an opposite end of the main body from the lower end, the upper end comprising an upper stop for limiting rotation of the load detection arm toward a tip of the fork and the lower end of the main body of the load detection arm comprises a slot for limiting rotation of the load detection arm away from the tip of the fork;
a rotary sensor coupled to the fork and associated with the load detection arm;
moving a load along the fork;
pivoting the load detection arm by the load as the load engages the load detection arm and moves along the fork;
detecting a change in angular position of the load detection arm via the rotary sensor, whereby the rotary sensor generates corresponding rotational signals;
determining the position of the load relative to a predefined location from the rotational signals as the load moves along the fork while engaged with the load detection arm.

10. The method of claim 9, wherein the load detection arm is directly coupled to the rotary sensor.

11. The method of claim 9, further comprising:
providing a lower limit element coupled to the mount, wherein the slot on the main body of the load detection arm comprises an open slot, when a portion of the main body of the load detection arm defining an end of the open slot engages the lower limit element, rotation of the load detection arm away from the tip of the fork is stopped.

12. The method of claim 9, wherein the rotary sensor comprises one of a rotary potentiometer or a rotary encoder hall-effect sensor.

13. A materials handling vehicle comprising:
a fork;
a pivotable load detection arm coupled to the fork;
a rotary sensor coupled to the fork and associated with the load detection arm, the rotary sensor generating rotational signals as the load detection arm pivots relative to the fork;
one or more memory devices for collectively storing executable instructions;
one or more microprocessors in communication with the one or more memory devices, wherein the one or more microprocessors are collectively configured when executing the executable instructions to:
receive the rotational signals from the rotary sensor;
enable or disable operation of one or more vehicle functions based on the rotational signals.

14. The materials handling vehicle as set forth in claim 13, wherein the one or more microprocessors are collectively configured to:
determine, from the rotational signals, the position of a load along the fork when the load is in contact with the load detection arm;
enable operation of one or more of the traction motor or a hydraulic motor to effect lift of the fork when the position of the load is within a first enablement threshold relative to a predefined location; and
at least one of:
disable operation of at least one of the traction motor or the hydraulic motor to effect lift of the fork when the position of the load is greater than a second enablement threshold relative to the predefined location; or
enable operation of an alert device when the position of the load is greater than the second enablement threshold relative to the predefined location;
wherein the second enablement threshold is greater than the first enablement threshold.

15. The materials handling vehicle as set forth in claim 14, wherein the one or more microprocessors may be collectively configured to:
disable one of the traction motor or the hydraulic motor when the position of the load is greater than the second enablement threshold relative to the predefined location and disable the other one of the traction motor or the hydraulic motor when the position of the load is greater than a third enablement threshold relative to the predefined location, the third enablement threshold is greater than the second enablement threshold.

16. A materials handling vehicle comprising:
a power unit comprising a frame, at least one driven wheel coupled to the frame, a traction motor for driving the driven wheel, and a motion sensor associated with the traction motor for generating motion signals;
a fork;
a pivotable load detection arm coupled to the fork;
a rotary sensor coupled to the fork and associated with the load detection arm, the rotary sensor generating rotational signals as the load detection arm pivots relative to the fork;
one or more memory devices for collectively storing executable instructions;
one or more microprocessors in communication with the one or more memory devices, wherein the one or more microprocessors are collectively configured when executing the executable instructions to:
control operation of the driven wheel;
receive the motion signals from the motion sensor;
receive the rotational signals from the rotary sensor;
enable operation of one or more vehicle functions based on at least one of the motion signals or the rotational signals.

17. The materials handling vehicle as set forth in claim 16, wherein the one or more microprocessors are collectively configured to:
determine from the motion signals the distance traveled by the power unit;
determine, from the rotational signals, the position of the load detection arm, and
during operation of the vehicle to pick a load with the fork, activating an alert device when the distance traveled by the power unit in a forks first direction is greater than a predefined distance and the position of the load detection arm, as determined by the rotational signals, has not moved past a predetermined angular position.

18. The materials handling vehicle as set forth in claim 17, further comprising:
a load handling assembly comprising:
a mast assembly coupled to the power unit;
a carriage assembly movably coupled to the mast assembly for vertical movement relative to and with the mast assembly;
a fork carriage mechanism to which the fork is mounted;
a reach mechanism coupled to the carriage assembly and the fork carriage mechanism for effecting movement of the fork carriage mechanism and the fork toward and away from the carriage assembly and the mast assembly; and
a reach assembly sensor for generating signals indicative of the distance that the fork carriage mechanism and the fork move relative to the mast assembly; and
wherein the one or more microprocessors are collectively configured to:
determine from the signals generated by the reach assembly sensor the distance that the fork travels away from the mast assembly; and
during operation of the vehicle to pick a load with the fork, activating the alert device when the combined distance traveled by the power unit in the forks first direction and the distance the fork travels away from the mast assembly is greater than a predefined distance and the position of the load detection arm, as determined by the rotational signals, has not moved past a predetermined angular position.

19. The materials handling vehicle as set forth in claim 16, wherein the one or more microprocessors are collectively configured to:
determine from the motion signals the distance traveled by the power unit;
determine, from the rotational signals, the position of the load detection arm, and
during operation of the vehicle to drop off a load on the fork, activating an alert device when the distance traveled by the power unit in a power unit first direction is greater than a predefined distance and the position of the load detection arm, as determined by the rotational signals, has not changed.

20. The materials handling vehicle as set forth in claim 19, further comprising:
a load handling assembly comprising:
a mast assembly coupled to the power unit;
a carriage assembly movably coupled to the mast assembly for vertical movement relative to and with the mast assembly;
a fork carriage mechanism to which the fork is mounted;
a reach mechanism coupled to the carriage assembly and the fork carriage mechanism for effecting movement of the fork carriage mechanism and the fork toward and away from the carriage assembly and the mast assembly; and
a reach assembly sensor for generating signals indicative of the distance that the fork carriage mechanism and the fork move relative to the mast assembly; and
wherein the one or more microprocessors are collectively configured to:
determine from the signals generated by the reach assembly sensor the distance that the fork travels toward the mast assembly; and
during operation of the vehicle to drop off a load on the fork, activating the alert device when the combined distance traveled by the power unit in the power unit first direction and the distance the fork travels toward the mast assembly is greater than a predefined distance and the position of the load detection arm, as determined by the rotational signals, has not changed.

21. The materials handling vehicle as set forth in claim 16, wherein the one or more microprocessors are collectively configured to determine more than four positions of a load on the fork relative to the predefined location as the load moves along the fork.
